(19) United States
(12) Patent Application Publication
(10) Pub. No.: US 2026/0346337 A1
(43) Pub. Date: Nov. 5, 2026

(54) ADDITIVE MANUFACTURING OF IMMISCIBLE MULTI-COMPONENT METALLIC SYSTEMS

(71) Applicant: Cornell University, Ithaca, NY (US)

(72) Inventors: Atieh MORIDI, Ithaca, NY (US); Sai Pratyush AKULA, Ithaca, NY (US); Jason A. SPECTOR, New York, NY (US); Xue DONG, Palisades Park, NJ (US)

(73) Assignee: Cornell University, Ithaca, NY (US)

(21) Appl. No.: 19/653,527

(22) Filed: Apr. 21, 2026

Related U.S. Application Data
(60) Provisional application No. 63/791,983, filed on Apr. 21, 2025.

(51) Int. Cl. B22F 10/28; B22F 10/50; B22F 10/64; B22F 10/66; B33Y 10/00; B33Y 40/20; B33Y 70/10; B33Y 80/00

(52) U.S. Cl. CPC B22F 10/28; B22F 10/50; B22F 10/64; B22F 10/66; B33Y 10/00; B33Y 40/20; B33Y 70/10; B33Y 80/00; B22F 2202/01; B22F 2202/05; B22F 2202/06; B22F 2301/058; B22F 2301/25; B22F 2301/35; B22F 2304/10; B22F 2998/10; B22F 2999/00

(57) ABSTRACT

Methods for producing structures by additive manufacturing include providing a substrate, providing a feedstock comprising a first metal or metal alloy and a second metal or metal alloy that is immiscible with respect to the first metal or metal alloy, providing an energy source, positioning the feedstock between the source of energy and the substrate, and activating the source of energy to melt a portion of the feedstock and deposit the melted portion of the feedstock onto the substrate or onto a workpiece on the substrate. These methods can be used to produce a number of structures, such as biodegradable implants with tunable degradation rates.

This application claims priority to U.S. Provisional Patent Application No. 63/791,983, filed Apr. 21, 2025, the content of which is hereby incorporated by reference in its entirety.

The present disclosure relates to additive manufacturing of immiscible or partially immiscible multi-component metallic systems with positive enthalpy of mixing between at least two components, and further relates to products made by such manufacturing methods and methods of using such products, including biodegradable implants.

### BACKGROUND AND SUMMARY OF THE INVENTION

Immiscible alloys are metallic systems with a positive enthalpy of mixing (ΔHmix), resulting in little to no solubility between the solute and solvent. A significantly positive ΔHmix for both liquid and solid phases leads to miscibility gaps, as seen in systems like Fe—Mg Fe—Cu, or Cu—Cr. In contrast, systems with a moderately positive liquid ΔHmix, such as Al—Sn, exhibit miscibility in the liquid phase but still undergo significant phase separation during cooling and solidification.

Immiscible alloys can be viewed as composites, where the unique characteristics of each element are combined to produce desirable properties suitable for target applications. Biodegradable implants are one example of a product that, in accordance with aspects of the present disclosure, can be produced from immiscible materials. Metal implants and plates are widely used in orthopedic and reconstructive applications, with titanium and titanium-based alloys being the typical materials for permanent implants. While permanent metal implants are necessary for joint replacement, temporary implants may be preferable for stabilizing bone segments during healing. Metal plates and screws are routinely employed to keep bone segments in rigid fixation, a necessary pre-condition for normal osseus healing. However, once the fracture heals, these metal implants can become problematic, serving as a potential source of infection, contributing to stress shielding of the bone or being visible, palpable, or uncomfortable for the patient. In such cases, surgery may be necessary to remove the implants.

The use of biodegradable implants offers an alternative to address the challenges associated with permanent implants. Although resorbable plates and screws made from materials such as poly(L-lactide-co-glycolide) are currently used clinically to overcome these challenges, they lack the strength of similar sized metallic implants and thus have limited indications for use. Thus, a degradable metal implant, which would be absorbed after bone healing is completed, presents an appealing solution. Iron (Fe) and Magnesium (Mg) are appealing candidates to make degradable implants and plates as both will corrode under physiologic conditions. However, their degradation rate is either too slow (in the case of Fe) or too fast (in the case of Mg) limiting their potential use cases, given that the bone healing period typically ranges from 4 to 24 weeks. Combining Fe and Mg in a composite structure could be a viable path to achieve degradation tunability. However, due to their miscibility gap, traditional fabrication methods may not be useful for fabricating Fe—Mg implants and plates.

Methods in accordance with aspects of the present disclosure can also be used to produce products having other desirable properties. A fine distribution of one immiscible element within a matrix of the other results in high hardness and strength (i.e., particle/precipitation strengthening). For instance, Cu in the Fe—Cu system enhances thermal conductivity while also providing strength thanks to fine Cu particles, and the dispersion of soft Sn in an Al matrix improves tribological properties, making the alloys particularly suitable for cylinder liners and bearings.

Despite their promising properties, the direct alloying of immiscible systems using conventional methods is challenging, because the constituent elements are not mixed, and Stokes sedimentation lead to macro-segregation of the elements. To mitigate this issue and obtain a well-dispersed microstructure in immiscible alloys, a variety of methods and techniques have been employed, such as rapid solidification techniques (e.g., thermal spray and melt spinning), microgravity, electromagnetic levitation, electric current pulses, and stirred casting. Recently, rapid solidification and melt flow circulation during additive manufacturing have been employed to fabricate immiscible alloys. However, despite the advantages of rapid solidification, challenges producing products suitable for end use remain. This is particularly true when the majority element has a higher melting point than the minority element.

### BRIEF DESCRIPTION OF THE EMBODIMENTS

According to the present disclosure, a method of producing a biodegradable implant by additive manufacturing includes providing a substrate, providing a feedstock comprising a first metal or metal alloy and a second metal or metal alloy having a positive enthalpy of mixing relative to the first metal or metal alloy, providing an energy source, positioning the feedstock between the laser and the substrate, and activating the energy source to emit energy onto a portion of the feedstock to liquefy the portion of the feedstock and deposit the liquefied portion of the feedstock onto the substrate or onto a workpiece on the substrate.

In some embodiments, the first metal or metal alloy is iron or a ferrous alloy.

In some embodiments, the second metal or metal alloy is magnesium of a magnesium alloy.

In some embodiments, the first metal or metal alloy is magnesium or a magnesium alloy.

In some embodiments, the feedstock is between about 0.05 vol % and 99.95 vol % iron and between about 0.05 vol % and 99.95 vol % magnesium.

In some embodiments, the first metal or metal alloy material is carbon coated iron.

In some embodiments, the melting point of the first metal or metal alloy and the melting point of the second metal or metal alloy differ by at least about 50 to about 3000 °C.

In some embodiments, the boiling point of the second metal or metal alloy is less than the melting point of the first metal or metal alloy.

In some embodiments, the method furth includes cooling the liquefied portion of the feedstock at a rate of about 10³ °K/s to about 10⁶ °K/s.

In some embodiments, the electrochemical potential of the second metal or metal alloy is greater than the electrochemical potential of the first metal or metal alloy.

In some embodiments, the feedstock includes iron, magnesium, manganese, copper, silver, tin, aluminum, gold, carbon, tungsten, chromium, platinum, zinc and/or calcium.

In some embodiments, the first metal or metal alloy is a first noble metal or metal alloy and the second metal or metal alloy is a second noble metal or metal alloy.

In some embodiments, the first metal or metal alloy is a powder having a particle size distribution of between about 5 μm and about 200 μm.

In some embodiments, the second metal or metal alloy is a powder having a particle size distribution of between about 5 μm and about 200 μm.

In some embodiments, the biodegradable implant comprises the second metal or metal alloy distributed in a matrix of the first metal or metal alloy.

In some embodiments, the method includes incorporating a pharmaceutical product into the biodegradable implant.

In some embodiments, the energy source is a laser that has a power of between about 50 W and about 5k W.

In some embodiments, the laser has a spot size of about 10 microns to about 10 mm.

The method of claim 1, wherein the electrochemical potential of the second metal or metal alloy is greater than the electrochemical potential of the first metal or metal alloy.

In some embodiments, the first metal or metal alloy and the second metal or metal alloy are at least partially immiscible.

In some embodiments, the enthalpy of mixing between the first metal or metal alloy and the second metal or metal alloy is positive.

In some embodiments, the method further includes modifying the surface of the first metal or metal alloy and/or the second metal or metal alloy prior to emitting energy on a portion of the feedstock.

In some embodiments, the modification includes coating the surface of the first metal or metal alloy and/or the second metal or metal alloy with a material that enhances energy absorption.

In some embodiments, the modification includes roughening the surface of the first metal or metal alloy and/or the second metal or metal alloy.

In some embodiments, the method further includes modifying the surface tension of at least a portion of the liquified feedstock.

In some embodiments, the method further includes providing sulfur in the feed stock to modify the surface tension of at least a portion of the liquified feedstock.

In some embodiments, the method further includes enhancing mixing of the first metal or metal alloy and the second metal or metal alloy in the liquified portion of the feedstock by vibrating the liquified portion of the feedstock.

In some embodiments, the method further includes enhancing mixing of the first metal or metal alloy and the second metal or metal alloy in the liquified portion of the feedstock by applying an electric field to the liquified portion of the feedstock.

In some embodiments, the method further includes enhancing mixing of the first metal or metal alloy and the second metal or metal alloy in the liquified portion of the feedstock by applying a magnetic field to the liquified portion of the feedstock.

In some embodiments, the method further includes processing the biodegradable implant to refine phase distribution of the first metal or metal alloy and the second metal or metal alloy and/or improve bonding between the first metal or metal alloy and the second metal or metal alloy.

In some embodiments, the method further includes heat treating the biodegradable implant.

In some embodiments, the method further includes mechanically processing the biodegradable implant.

In some embodiments, the method further includes surface treating the biodegradable implant.

In some embodiments, the feedstock further includes a third metal or metal alloy.

In some embodiments, the third metal or metal alloy is at least partly immiscible with respect to the first metal or metal alloy and/or the second metal or metal alloy.

According to another aspect of the present disclosure, a method of controlling the in vivo degradation rate of a biodegradable implant includes selecting a desired range for the in vivo degradation rate of the implant, selecting a first metal or metal alloy that has an in vivo degradation rate outside the desired range for the in vivo degradation rate of the implant, selecting a second metal or metal alloy having an in vivo degradation rate outside the desired range for the in vivo degradation rate of the implant and which differs from the in vivo degradation rate of the first meta, and producing the implant from a first amount of the first metal or metal alloy and a second amount of the second metal or metal alloy, the first and second amounts selected so that the in vivo degradation rate of the implant is within the desired range for the in vivo degradation rate of the implant.

In some embodiments, the biodegradable implant comprises the second metal or metal alloy distributed in a matrix of the first metal or metal alloy.

In some embodiments, the electronegativity of the second metal or metal alloy is greater than the electronegativity of the first metal or metal alloy.

In some embodiments, the implant is configured to treat a bone fracture or osteotomy and the desired range for the in vivo degradation rate of the implant is selected at least in part based on the anticipated healing time of the bone fracture.

In some embodiments, the first metal or metal alloy and/or the second metal or metal alloy include iron, a ferrous alloy, magnesium, a magnesium alloy, manganese, copper, silver, tin, aluminum, gold, carbon, tungsten, chromium, platinum, zinc and/or calcium.

In some embodiments, the first metal or metal alloy and the second metal or metal alloy are at least partially immiscible.

In some embodiments, the enthalpy of mixing between the first metal or metal alloy and the second metal or metal alloy is positive.

According to another aspect of the present disclosure, a method of controlling in vivo pH at the site of an implant includes selecting a desired in vivo pH range at the implant site, selecting a first metal or metal alloy that produces a first in vivo reaction product as the first metal or metal alloy degrades, the first in vivo reaction product having a first effect on in vivo pH at the implant site, selecting a second metal or metal alloy that produces a second in vivo reaction product as the second metal or metal alloy degrades, the second in vivo reaction product having an opposing effect on in vivo pH at the implant site as compared to the effect of the first reaction product, and producing the implant from a first amount of the first metal or metal alloy and a second amount of the second metal or metal alloy, the first and second amounts selected so that the combined effects of the first reaction product and the second reaction product produce at pH at the implant site that is within the desired in vivo pH range at the reaction site.

In some embodiments, the biodegradable implant comprises the second metal or metal alloy distributed in a matrix of the first metal or metal alloy.

In some embodiments, the desired in vivo pH range at the implant site is between about 6.0 and about 8.0.

The method of claim 23, wherein the first metal or metal alloy and/or the second metal or metal alloy include iron, a ferrous alloy, magnesium, a magnesium alloy, manganese, copper, silver, tin, aluminum, gold, carbon, tungsten, chromium, platinum, zinc and/or calcium.

In some embodiments, the first metal or metal alloy and the second metal or metal alloy are at least partially immiscible.

In some embodiments, the enthalpy of mixing between the first metal or metal alloy and the second metal or metal alloy is positive.

In some embodiments, a biodegradable implant is made in accordance with methods of the present disclosure.

According to another aspect of the present disclosure, a method of producing a structure by additive manufacturing includes providing a substrate, providing a feedstock comprising a first metal or metal alloy and a second metal or metal alloy that is immiscible with respect to the first metal or metal alloy, providing an energy source, positioning the feedstock between the source of energy and the substrate, and activating the source of energy to melt a portion of the feedstock and deposit the melted portion of the feedstock onto the substrate or onto a workpiece on the substrate.

In some embodiments, the feedstock includes iron, a ferrous alloy, magnesium, a magnesium alloy, manganese, copper, silver, tin, aluminum, gold, carbon, tungsten, chromium, platinum, zinc and/or calcium.

In some embodiments, the first metal or metal alloy and the second metal or metal alloy are at least partially immiscible.

In some embodiments, the enthalpy of mixing between the first metal or metal alloy and the second metal or metal alloy is positive.

In some embodiments, the method further includes modifying the surface of the first metal or metal alloy and/or the second metal or metal alloy prior to activating the source of energy.

In some embodiments, the modification includes coating the surface of the first metal or metal alloy and/or the second metal or metal alloy with a material that enhances energy absorption.

In some embodiments, the modification includes roughening the surface of the first metal or metal alloy and/or the second metal or metal alloy

In some embodiments, the method further includes modifying the surface tension of at least a portion of the melted feedstock.

In some embodiments, the method further includes providing sulfur in the feed stock to modify the surface tension of at least a portion of the melted feedstock.

In some embodiments, the method further includes enhancing mixing of the first metal or metal alloy and the second metal or metal alloy in the melted portion of the feedstock by vibrating the melted portion of the feedstock.

In some embodiments, the method further includes enhancing mixing of the first metal or metal alloy and the second metal or metal alloy in the melted portion of the feedstock by applying an electric field to the melted portion of the feedstock.

In some embodiments, the method further includes enhancing mixing of the first metal or metal alloy and the second metal or metal alloy in the melted portion of the feedstock by applying a magnetic field to the melted portion of the feedstock.

In some embodiments, the method further includes processing the structure to refine phase distribution of the first metal or metal alloy and the second metal or metal alloy and/or improve bonding between the first metal or metal alloy and the second metal or metal alloy.

In some embodiments, the method further includes heat treating the structure.

In some embodiments, the method further includes mechanically processing the structure.

In some embodiments, the method further includes surface treating the structure.

In some embodiments, the structure is a biodegradable implant.

In some embodiments, the additive manufacturing process is laser beam powder bed fusion.

In some embodiments, the additive manufacturing process is electron beam powder bed fusion.

In some embodiments, the additive manufacturing process is direct energy deposition.

In some embodiments, the feedstock further includes a third metal or metal alloy.

In some embodiments, the third metal or metal alloy is immiscible with respect to the first metal or metal alloy and/or the second metal or metal alloy and has phase separation with the first metal or metal alloy and/or the second metal or metal alloy.

In some embodiments, at least one of the first metal or metal alloy or the second metal or metal alloy is carbon coated.

In some embodiments the method further includes providing an excess amount of at least one of the first metal or metal alloy or the second metal or metal alloy to account for material loss occurring when the method is performed.

In some embodiments, the application of energy to the feedstock results at least in part in a solid state bond between the first metal or metal alloy and the second metal or metal alloy.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a group of SEM images of pure Fe, AZ31, and Fe-AZ31.

FIG. 2 is a higher magnification SEM of the Fe-AZ31 sample.

FIG. 3 shows large field of view micrographs of pure Fe, AZ31 and Fe-AZ31 of FIG. 1.

FIG. 4 is a stacked XRD plot of the pure Fe, AZ31, and Fe-AZ31 samples.

FIG. 5 shows the change in enthalpy of mixing with varying Mg composition.

FIG. 6 shows variations in the colors of simulated body fluid (SBF) solutions in which the pure Fe, AZ31, and Fe-AZ31 samples were immersed for degradation studies.

FIG. 7 presents the quantitative results from the in vitro degradation studies.

FIG. 8 presents SEM and EDS images of the pure Fe sample after 8 weeks of in vitro testing.

FIG. 9 presents SEM and EDS images of the AZ31 sample after 8 weeks of in vitro testing.

FIG. 10 presents SEM and EDS images of the Fe-AZ31 sample after 8 weeks of in vitro testing.

FIG. 11 is an XRD plot of the pure Fe, AZ31 and Fe-AZ31 samples post in vitro studies showing the reaction products.

FIG. 12 illustrates degradation rates of iron and its alloys synthesized via different manufacturing techniques and varying compositions.

FIG. 13 is a schematic illustrating different factors influencing the corrosion and thus the degradation rate of the Fe-AZ31 of the second sample set synthesized via DED.

FIG. 14 is a processing map of certain laser parameters utilized in accordance with aspects of the present disclosure.

FIG. 15 illustrates melt pool boundaries of materials processed in accordance with the processing map of FIG. 14.

FIG. 16 illustrates melt pool dimensions.

FIG. 17 illustrates features of the melt pool keyholes.

FIG. 18 illustrates probability density function maps for melt pool keyholes.

FIG. 19 illustrates the distribution of Al and Sn in systems of the present disclosure.

FIG. 20 is a group of SEM images of Al and Sn in systems of the present disclosure.

FIG. 21 is a group of melt pool images at different points in time.

FIG. 22 illustrates velocity fields within the melt pools.

FIG. 23 illustrates velocity fluctuations in melt pools in the horizontal direction.

FIG. 24 illustrates melt pool velocity profiles from the top to the bottom of the melt pools.

FIG. 25 schematically illustrates the effects of certain factors on melt pool flow.

FIG. 26 illustrates a schematic of the melt pool profile and a force balance of a static keyhole.

### DETAILED DESCRIPTION OF EMBODIMENTS OF THE DISCLOSURE

Biodegradable implants in accordance with at least some aspects of the present disclosure are formed from iron or a ferrous alloy and magnesium or a magnesium alloy. The addition of magnesium to iron improves the degradation kinetics of the iron matrix because magnesium, being a more electronegative metal, forms galvanic sites within the iron matrix and prevents localized pitting. However, because iron and magnesium are immiscible, they tend to phase separate during melt-based processes. Certain aspects of the present disclosure address this issue through additive manufacturing. The use of additive manufacturing processes tends to lessen or prevent phase separation because such processes (i) have very high cooling rates (10³-10⁶ K/s) limiting the time for phase separation, (ii) produce Marangoni convection-induced natural mixing of molten metals, and (iii) produce small melt pool dimensions in comparison to the part ensuring that any segregations during the manufacturing process occur on scales below the melt pool dimensions, typically sub-millimeter. While large scale segregations could be undesirable, such small scale segregations created during the manufacturing process allow introduction of numerous sacrificial cells/sites across the iron matrix, thus improving its degradation kinetics. In accordance with the present disclosure, aspects (i)-(iii) inherent in additive manufacturing can be augmented with external forces, for example ultrasonic vibration of the build plate, electric, or magnetic fields, to enhance agitation of the melt pool.

In one aspect of the present disclosure, a Formalloy Technologies, Inc. (Spring Valley, California) X2 Directed Energy Deposition (DED) system equipped with an ytterbium fiber laser of 1.2 mm spot size and a maximum power output of 500 W was used to print Fe-AZ31B samples having dimensions of 20 mm×8 mm×5 mm on a 3 mm thick SS304 substrate. The samples were printed using pure Fe powder of particle size 25-45 μm and AZ31B alloy powder of particle size distribution 105-150 μm. AZ31B is an alloy of magnesium with a typical composition of 3 wt % Al, 1 wt % Zn and 96 wt % Mg.

Pure Fe and 10at % of AZ31 (which is about 5 wt % or 15 vol %) were mixed using a low energy ball mill for 30 minutes to ensure consistency in the feedstock powder mixture. Pure Fe and AZ31 powders were also printed to provide a baseline for comparison of degradation kinetics. The print parameters are listed in Table 1. The optimal print parameters were narrowed down by altering the conditions to achieve a print that matched the expected sample height and had a surface free of any visible abnormalities. All sample manufacturing performed in an inert atmosphere of <100 ppm of oxygen to prevent/reduce oxidation of samples during the printing process.

TABLE 1
Process parameters for printing different material systems

| | | | | Layer | Hatch |
|---|---|---|---|---|---|
| | Laser Power | Scan Speed | Feed | Height | Spacing |
| Material | (W) | (mm/min) | (rpm) | (mm) | (mm) |
| Fe | 300 | 1200 | 0.6 | 0.2 | 0.6 |
| AZ31 | 170 | 1400 | 0.6 | 0.2 | 0.6 |
| Fe—Mg | 300 | 1400 | 0.55 | 0.2 | 0.6 |

The samples were sectioned using a low speed saw to obtain cross sections. The cross sections were flattened using 120-grit sandpaper with water as the coolant. The flattened samples were further ground using sandpaper to 1200 grit. The samples containing magnesium were then polished using an oil-based diamond suspension of particle sizes 3 μm, 1 μm, and 0.5 μm in succession. The final polish for these samples was performed using 0.05 μm water-free colloidal silica solution. The pure iron sample was polished using water-based alumina suspension of particle sizes 1 μm and 0.3 μm. The final polish for the pure iron samples was performed using a colloidal silica solution with the particle size of 0.08 μm.

The cross sections of each material system—pure Fe, AZ31, and Fe-AZ31 were imaged using a scanning electron microscope (SEM) in secondary electron (SE) and back scattered electron (BSE) modes. The elemental composition of the samples was analyzed using energy-dispersive x-ray spectroscope. The surface elemental analysis was performed in three different locations on the samples. X-ray diffraction analysis was performed to confirm the phases present in each sample. Surface defects of the samples were measured with ten unique regions imaged using an optical microscope.

In vitro degradation studies were performed using both 2D and 3D analysis. For 2D analysis, a set of samples were mounted in a resin with one face grinded to 1200 grit. This ensured that a uniform 8 mm×8 mm area was exposed to the simulated body fluid (SBF) and formed the corresponding reaction products. For 3D analysis, 8 mm×8 mm×4 mm sized samples were cut from the printed samples using a low speed saw. One sample of each composition was immersed in 100 ml simulated body fluid (SBF) which was maintained at 37 °C to emulate human physiological conditions. The samples were weighed prior to immersion and the pH of the SBF solution was adjusted to 7-7.4 to match that of the human body. Initially, the pH and weights of the samples were noted every day. After the AZ31 sample fully degraded, the frequency of these readings was reduced to every other day. These in vitro degradation studies were carried out for 65 days. The SBF solution was completely replaced every 2 days for the samples that were used for calculating mass loss. For samples monitored for pH changes, the SBF solution was retained throughout the study period to observe long-term pH trends.

The compositions of the biodegradation products and surface morphologies of the samples following in vitro degradation studies were examined using an SEM equipped with energy-dispersive x-ray spectroscopy (EDS). To better study the surface evolution, a set of samples were mounted in a resin with one face ground to 1200 grit. This ensured that a uniform 4 mm×4 mm area was exposed to the SBF to form the corresponding reaction products. A Bruker D8 General Area Detector Diffraction System (GADDS) with 0.5 mm aperture was used to identify the reaction products.

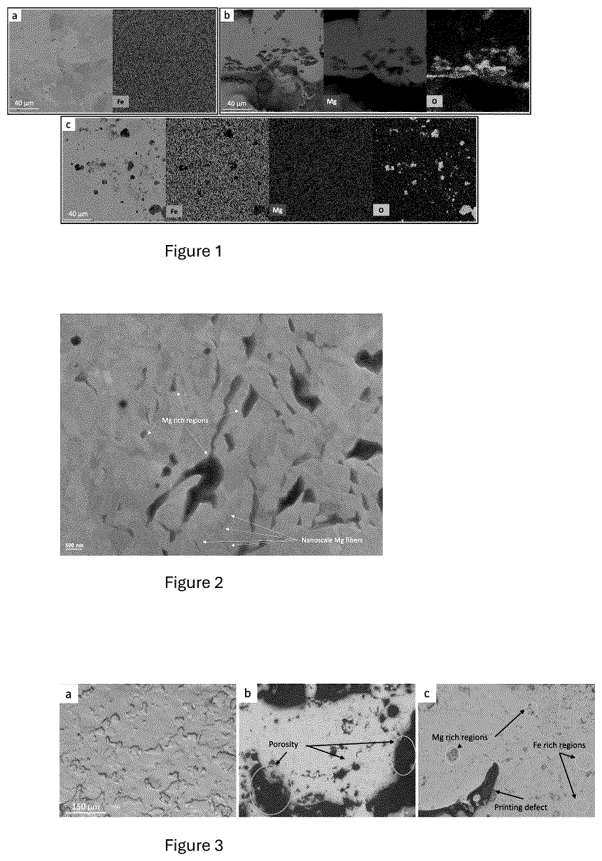

FIG. 1 shows the SEM images of pure Fe, AZ31 and Fe-AZ31 composite captured in BSE mode along with their corresponding EDS maps. Pure Fe, shown in FIG. 1(a) is mostly defect free and fully dense. FIG. 1(b) is a microstructural image of the AZ31 sample which, shows the presence of numerous voids which can be detrimental to the structural integrity and degradation properties of the sample. The EDS maps give a good representation of the porous region of the sample. Along with printing defects (porosity), the sample also shows the presence of oxide rich regions which could be oxides of magnesium formed during the printing process. Finally, FIG. 1(c) reveals the microstructure of the Fe-AZ31 composite with magnesium-rich as the darker regions in the image and iron-rich being the brighter matrix. The Mg-rich regions also show enrichment in oxygen indicating the potential formation of magnesium oxide during the synthesis. The EDS analysis also shows a presence of 2.65±0.507 at % Mg (equivalent to about 4 vol % of Mg) in the samples which is much less than 10at % in the initial powder feedstock mixture. FIG. 2 presents a higher magnification SEM micrograph of the Fe-AZ31 sample that shows the different sized Mg rich domains in the printed sample. Mg is spread across the Fe matrix in various sizes and shapes (spherical, fibers, etc.).

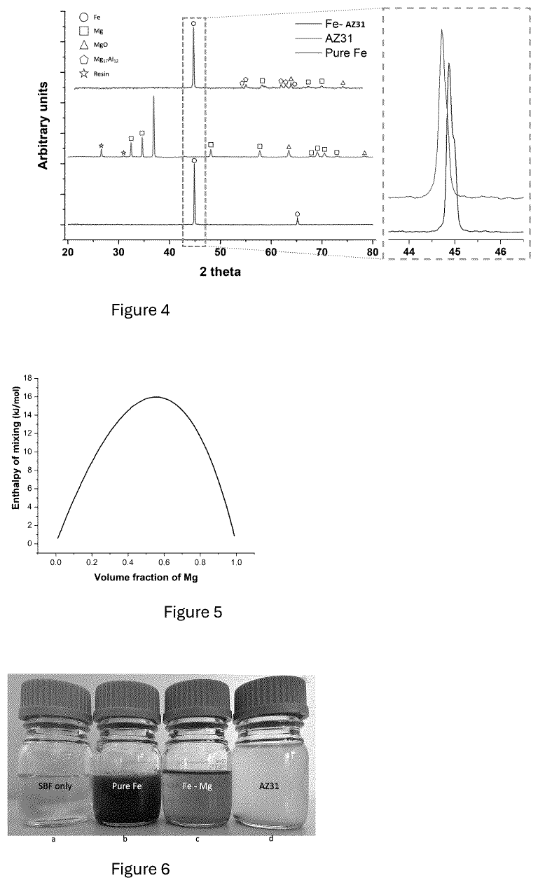

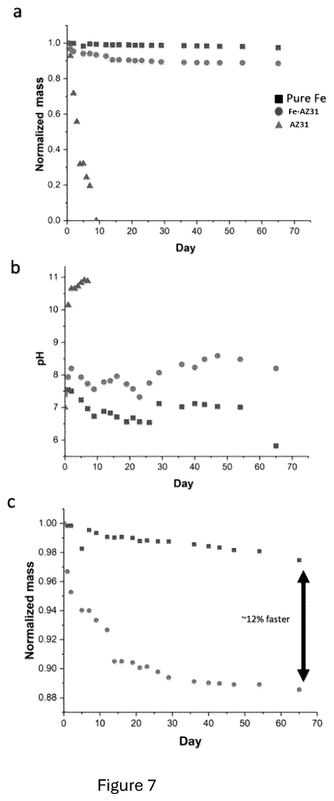

FIG. 4 presents a stacked XRD plot of pure Fe, AZ31, and the Fe-AZ31 composite samples. XRD confirmed that the oxygen rich sites seen in the AZ31 sample (FIG. 7(b)) are MgO. XRD also discloses the presence of Mg₁₇Al₁₂ intermetallic, along with the retention of Mg and MgO. In the case of the Fe-AZ31 composite, it can be noted that none of the major Mg peaks show up in XRD and the major Fe peaks (at around 45° and) 65° have shifted slightly towards the lower 2 theta. This can be attributed to the partial dissolution of the hcp Mg phase in the bcc Fe phase. The enthalpy of mixing for these metals was calculated using the Miedema calculator of the Entall database. FIG. 5 shows the change in enthalpy of mixing with varying composition.

FIG. 6 shows the variations in the colors of solutions in which the samples were immersed for degradation studies. FIG. 6(a) shows SBF, FIG. 6(b) shows SBF with pure Fe, FIG. 6(c) shows SBF with Fe-AZ31 composite, and FIG. 6(d) SBF with AZ31 respectively. While the color of the solution does not help quantify any degradation, it provides qualitative insights into the various phenomena occurring. First, the SBF solution without any sample in it is a clear solution as it is simply an aqueous solution of various salts. The vial containing the SBF solution with the Fe samples immersed in it turned into a characteristic orange-red color. This coloration can be attributed to the formation of iron oxide and other complex iron oxides (rust) when iron reacts with water (eqns. 1-6). The solution with the AZ31 sample turned the entire solution cloudy white due to the formation of a thin hydroxyapatite (HAP) layer on the sample surface along with calcium phosphate compounds and magnesium hydroxide that is dispersed in the solution (eqns. 7-9). The reaction of magnesium with water releases hydrogen gas and hydroxyl ions which leads to an increase in the pH, first close to the metallic surface and eventually the entire solution. This local rise in pH near the surface of the metal could facilitate the formation of calcium phosphate compounds. The vial in which the Fe-AZ31 composite was immersed showed an intermediate color to that of pure Fe and AZ31. This is potentially due to the presence of a mix of the reaction products discussed above for each of the pure metal solution.

Fe→Fe²⁺+2e⁻ (anodic reaction) (eqn. 1)

O₂+2H₂O+4e⁻→4OH⁻ (cathodic reaction) (eqn. 2)

Fe²⁺+2OH⁻→Fe(OH)₂ (reaction products) (eqn. 3)

Fe²⁺+2Cl⁻→FeCl₂ (eqn. 4)

Fe(OH)₂+(¼)O₂+(½)H₂O→Fe(OH)₃ (eqn. 5)

3Fe(OH)₂+(½)O₂→Fe₃O₄+3H₂ (eqn. 6)

Mg+2H₂O→Mg(OH)₂+H₂ (eqn. 7)

Mg(OH)₂+Cl⁻→MgCl₂ (promotes magnesium corrosion) (eqn. 8)

Due to local increase in pH-calcium phosphate compounds are formed

5Ca²⁺+3PO₄³⁻+OH⁻→Ca₅(PO₄)₃(OH) (eqn. 9)

FIG. 7 presents the quantitative results from the 3D in vitro degradation studies. FIG. 7(a) shows the mass change of each of the sample plotted over the 65-day study period. AZ31 demonstrated the fastest degradation, almost fully disintegrating in about 10 days, likely due to its high porosity as observed in FIG. 1(b). The pure Fe sample exhibited the slowest degradation rate with minimal mass change. The printed Fe-AZ31 composite showed 12% increase in degradation compared to pure Fe (FIG. 7(c)), validating the efficacy of methods according to aspects of the present disclosure of adding magnesium to enhance iron's degradation rate. FIG. 7(b) provides insights into the pH changes of the solution. The AZ31 sample had a very steep increase in pH to over 11. As noted above, this is due to magnesium readily reacting with water to form Mg(OH)₂ which is a basic compound. In contrast, iron upon reaction with water forms complex iron oxides which are amphoteric in nature that could be the potential cause for the little fluctuations in its pH readings.

The 3D printing of magnesium and its alloys is known to be challenging due to phenomena like vaporization of magnesium powder, splatter, and high reactivity. These issues caused the samples to be defect ridden (i.e., the samples showed large volumes of porosity). Using DED to manufacture the samples further exacerbated this due to high thermal densities and gradients inherent in the process. These resulting effects of manufacturing magnesium samples using DED can be seen in the microstructural image shown in FIG. 1(b).

Manufacturing the Fe-AZ31 samples was challenging for several reasons. The primary challenge was a result of the vast gap in the melting point of the metals (650 °C for magnesium and 1350 °C for iron). This difference in melting points meant that each phase requires a different energy density to melt and fuse with the previous layer(s). It is hypothesized that these issues can be overcome by modifying the Fe and/or Mg powders prior to processing, such as by surface modification. Examples include:
Carbon Coating Fe Powders: It is believed that coating the iron powder with carbon prior to the printing process will reduce the required input energy to melt it and hence reduce the vaporization of magnesium during the printing process. This is because carbonaceous materials can function as near black body materials thus increasing the laser absorbance, whereas metals such as Fe and Mg have laser absorptivity of around 30% and 40% respectively (at 1064 nm wavelength). This approach may reduce the gap in the energy density that is required to melt Fe and Mg concurrently. Carbon can also enhance the mechanical performance of Fe by solid solution strengthening. If excess carbon is present, it could further increase the degradation rate of Fe as it will precipitate out of the solid solution and act as new galvanic sites to initiate degradation.
Fe Coating Mg Powder: Laser absorption primarily occurs at the surface level. When creating core-shell Fe—Mg powders with a coating, the incident beam will mainly be absorbed by the Fe layer, allowing only the attenuated beam to reach the Mg core. By adjusting the thickness of the Fe coating, the degree of laser beam attenuation can be controlled as well as the proportion of Fe in the final composite. Mg powders can be coated by an electroless plating method using an electrolyte (plating solution) based on FeSO4·7H2O. The magnesium powder and electrolyte are mixed in a beaker and maintained at a pH of 9.5 and a temperature of 80 °C for a duration of 40 minutes. The coating thickness can be modified by varying the concentration of iron sulfate in the plating solution. Once the coating process is completed, the composite powders can be washed and dried.

Besides the difference in melting point, additional issues can be attributed to the fact that magnesium has a boiling point less than that of iron's melting point. Such a difference meant loss of magnesium phase in the form of vapors during the printing process, along with instabilities in the melt pool. Aspects of the present disclosure overcame these challenges through optimization of the print parameters, which led to successful printing of near fully dense Fe-AZ31 composites. Despite these challenges, aspects of the present disclosure result in samples with minimal defects (3.528%±0.889%) as shown in FIGS. 1(c) and 3(c). FIG. 3(a) also shows the pure Fe sample (etched) that is dense with no visible porosity at this length scale. FIG. 3(b) is a micrograph of the AZ31 sample which shows regions marked with porosity. The porosity in this sample at the current scale was calculated to be 20.72±11.95%. FIG. 3(c) shows the Fe-AZ31 composite with marked Mg-rich regions that show up as a darker contrast in the images along with a few printing defects. While a substantial amount of the magnesium was still lost in the form of vapors, the samples in accordance with aspects of the present disclosure retained about 3 at % (2.65±0.507 at %) of magnesium in the composite (about a fifth of the initial feedstock mixture). Furthermore, the magnesium was distributed throughout the iron matrix as evidenced from FIGS. 1 and 3.

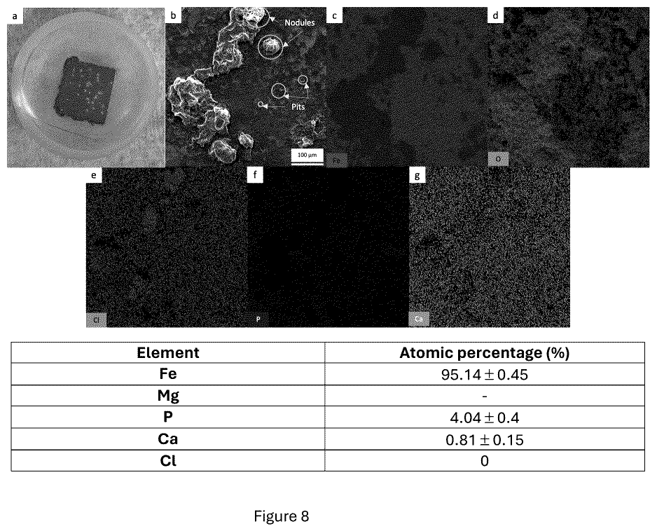

FIG. 8(a) shows the macroscopic view of the Fe sample after 4 weeks of in vitro degradation along with the BSE image. This image does not show any apparent degradation of the sample, but does show the presence of white agglomerates that are its reaction products. FIGS. 8(a-e) are the SEM and EDS analysis of the corroded surface. From the SEM image (FIG. 8(a)) it can be seen that there are surface nodules formed in some regions and pits at few sites. In vitro degradation of iron can show varied reaction products based on the composition of the immersion solution and the test conditions. The reaction products can be oxygen, calcium, hydroxide, oxyhydroxide, or chlorine rich. The EDS maps (FIGS. 8(b-e)) show that most of the reaction products of the samples produced are oxygen rich, while some regions are rich in chlorine (i.e., parts of the nodules show a higher concentration of chlorine). Phosphorous is also present throughout the sample without any evidently enriched regions.

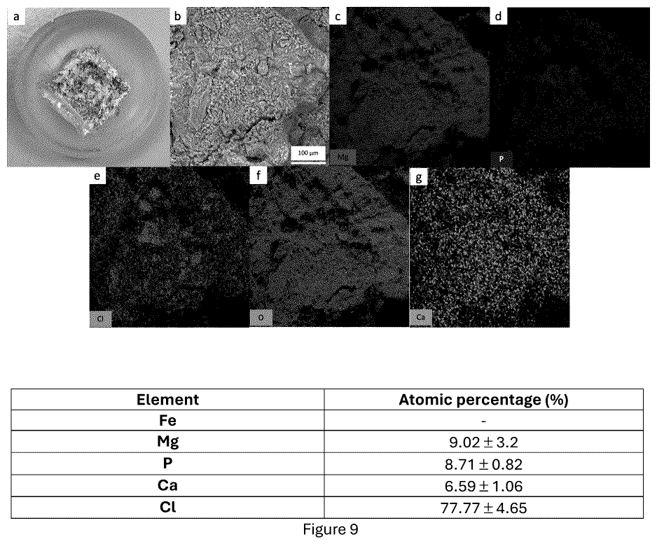

FIG. 9(a) is an overview image of a AZ31 sample and its corresponding BSE image post immersion studies. This macroscale image shows a clear loss of material, unlike the pure Fe sample. This sample is also covered by a thin white film on the surface. It is evident from the SEM image, FIG. 9(a), that parts of the sample broke away during the degradation process. While some of this is due to the reaction of magnesium with the SBF solution, some of the degradation is also due to the lack of fully dense samples. The large printing voids in the sample shown in FIG. 1(b) could act as breakaway points, leading to accelerated degradation of the sample. FIG. 9(b-e) shows the various elemental maps of the sample post degradation. The reaction products shown in the EDS maps show a strong proclivity towards forming phosphate based products, which could be an indication of HAP film on the surface of Mg. There are also regions that showing chlorides, confirming the reactions taking place in the regions with high pH (eqn. 8).

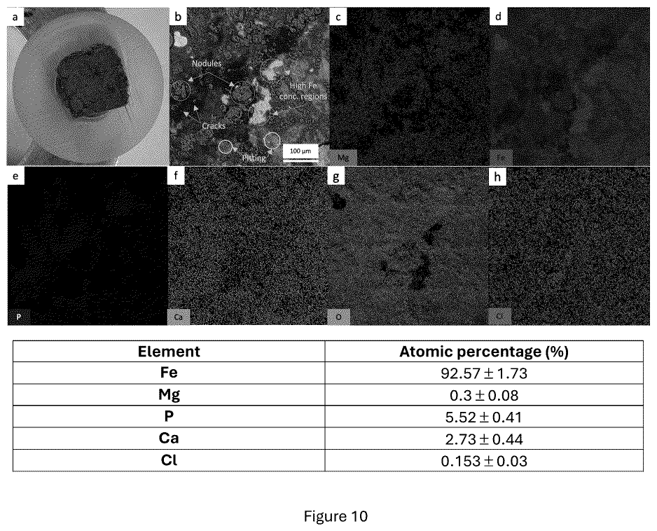

FIG. 10(a) is a macroscopic overview of the Fe-AZ31 sample and its BSE image post immersion studies. This image shows a few regions with more degradation that the others. FIGS. 10(a-f) consist of the SEM image and the EDS maps for the Fe—Mg composite after the sample was retrieved from the in vitro degradation studies. The SEM image reveals the combination of surface phenomenon observed in the pure Fe and AZ31 samples. This is hypothesized to be due to the galvanic cells formed by the more electronegative Mg that is dispersed across the iron matrix. The Mg sites are selectively attacked by the SBF first, thus degrading it and leaving behind pits in the iron matrix. This specific phenomenon essentially fastens the pitting process of iron and enhances its overall degradation kinetics. Similar to the AZ31 sample, the magnesium rich regions show a higher concentration of phosphates, whereas the iron rich regions show either nodules or oxide rich regions on the surface. The combination of reactions in the composite indicates the possibility of HAP formation.

FIGS. 8-10 illustrate various aspects of Sample Set. FIG. 8 shows the macroscopic view of the 2D pure Fe, along with surface topology and corresponding elemental EDS maps post immersion studies. These samples show two distinct features-nodules on the surface and micro-pitting. However, FIG. 9(a) shows an apparent loss of material in the AZ31 sample post immersion. The elemental EDS maps reveal phosphorus and calcium enrichment in overlapping regions. FIG. 10(a-f) show the macroscopic overview of the Fe-AZ31 sample, an SEM image of a representative region, and the EDS maps for the Fe-AZ31 composite after the sample was retrieved from the in vitro degradation studies. The SEM image reveals the combination of surface phenomenon observed in the pure Fe and AZ31 samples as shown in FIGS. 8 and 9 respectively. The magnesium rich regions show a higher concentration of phosphorus and calcium whereas the non-magnesium rich regions show nodules on the surface along with regions of high Fe concertation. The Mg rich regions show cracks upon corrosion whereas the Fe matrix shows regions of pitting wherever nodules are not present on the surface. The high Fe concentration regions are also depleted in oxygen (as seen in the elemental EDS maps) which could possibly be due to the to the more negative electrochemical potential of Mg, making the Mg rich sites more prone to reaction with the SBF while leaving the Fe region less affected. Upon quantification of the various elements that form reaction products on the metal surface, it was observed that the Fe-AZ31 sample exhibits higher concentration of P, Ca and Cl compared to pure Fe, but less than that of AZ31. This could be attributed to the phosphorous based reaction products and MgCl₂ formation that are only observed in the AZ31 sample.

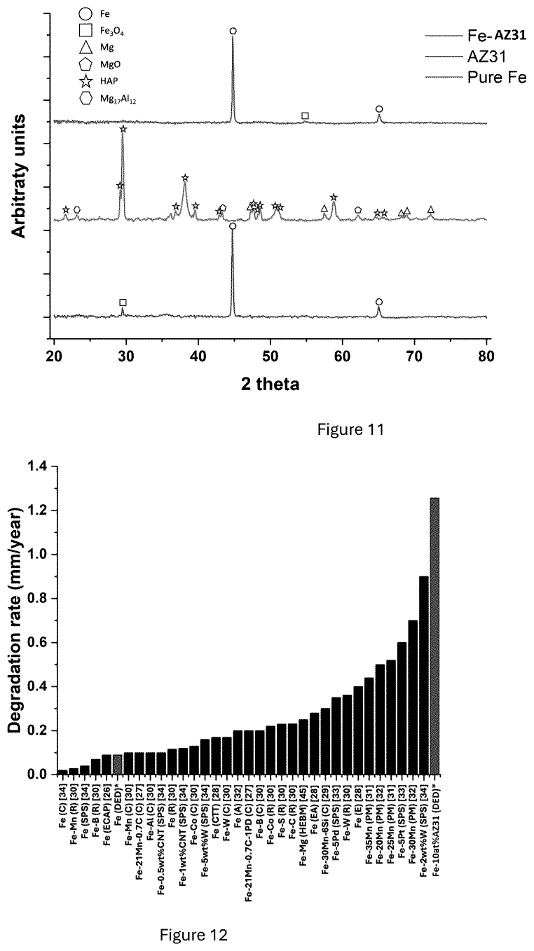

FIG. 11 shows the stacked XRD plot for all three samples after the immersion studies. Indexing the peaks for all the samples reveals that the prominent reaction product for pure Fe sample after immersion is Fe₃O₄ and for AZ31 reveals the appearance of new hydroxyapatite (HAP) peaks. The MgO and Mg₁₇Al₁₂ peaks are most likely from the manufacturing process rather than degradation studies since these peaks are also present in as printed samples shown in FIG. 4. Although prominent HAP peaks are not detected in the Fe-AZ31 sample by powder XRD, this may be due to the low volumes of HAP present on the sample's surface, which could fall below the detection limit of powder XRD. However, the increased concentrations of P and Ca, compared to pure Fe (as seen in the EDS elemental quantification), suggest the potential formation of HAP on the Fe-AZ31 composite surface.

HAP is a biomineral that makes up most of the bone tissue. This mineral, when present on the surface of an implant, provides useful characteristics such as surface roughness, porosity and solubility. These influence and enhance the proliferation and adhesion of osteoblasts which will in turn enhance osteogenesis. Numerous approaches have been taken to utilize synthetic or natural HAP to enhance bone regeneration and healing. Some common ways include coating the implant with HAP or doping it with HAP during the manufacturing process. FIG. 10 discussed above shows the potential formation of HAP in both the AZ31B and Fe-AZ31 composite. This is further confirmed by the XRD results from post immersion samples as shown in FIG. 11. Due to the formation of this HAP film on the sample during degradation, there is potential for the Fe-AZ31 composite to promote superior osteogenesis while having better degradation kinetics than traditional iron implants.

AZ31 samples rapidly degraded, leading to complete mass loss in about 10 days and resulting in solution pH above 10. This rise in pH can be attributed to the release of hydrogen gas, a byproduct of magnesium reacting with water. From Eqn. 7, for every 1 g of dissolved Mg, 1 L of hydrogen gas will be produced. The rapid reaction kinetics of Mg results in large hydroxyl ion production, resulting in a sharp pH increase and causing hydrogen gas to emanate from the implant surface. On the other end of the spectrum was iron, where the solution had a final pH that was slightly acidic (6.4-6.6). This indicates that the oxides formed by iron are slightly acidic (although they can be amphoteric in nature).

With respect to the Fe-AZ31 samples, as Mg corrodes, (OH) is released, which results in an initial increase of local surface pH (which can go up to ~12) and subsequently an increase in the bulk pH of the solution. But as seen from the results of the in vitro degradation of pure Fe, its oxide tends to behave as an acidic oxide. The opposite nature of the oxides results in continuous fluctuations in the pH based on the dominant oxide in the solution (FIG. 7(b)). That is, if magnesium rich sites are available for degradation, the pH of the solution tends to increase, whereas when there are no Mg sites available, Fe undergoes degradation to form acidic oxides which results in a decrease of the solution's pH.

In Fe-AZ31 composites according to aspects of the present disclosure, the increase in pH is curbed for two reasons—lower direct availability of Mg on surface and acidic oxide produced due to the degradation of iron. There is less available Mg on the surface for degradation compared to a magnesium-based implant, as it is dispersed in an iron matrix thus dynamically becoming available for the solution to undergo corrosion. Meanwhile, as magnesium corrodes leaving pits in the iron matrix, local degradation of iron accelerates and produces complex iron oxides (rust) which can act as an acidic oxide, thus countering the pH increase from Mg dissolution.

This phenomenon could partially counteract one of the main issues with magnesium (and its alloys) implants, i.e., hydrogen evolution causing gas cavities in the nearby tissues. The counteracting nature of the iron degradation suppresses the release of hydrogen gas and maintains the pH close to that of the human body. Furthermore, the presence of iron, the presence of magnesium promotes the formation of ACP and HAP, which could aid in bone healing and recovery (along with good osseointegration).

The interplay between Fe and Mg likely introduces several mechanisms that could enhance the degradation kinetics of Fe, fundamentally altering its behavior. First, magnesium's electrochemical potential, that is more negative than iron, initiates the corrosion process at its sites. This initial degradation of Mg may expose the unreacted Fe surface beneath it, preventing the formation of passivation layer that Fe would typically develop to slow down its own corrosion. The continuous exposure of unreacted Fe surfaces could keep the metal in an active state, thus potentially accelerating its degradation. Fe implants typically suffer from localized pitting in a Cl⁻ environment, which could lead to unpredictable mechanical failure. However, with distributed Mg sites (as shown in the FIG. 1(c) and FIG. 2) acting as sacrificial anodes, the formation of numerous small pits could result in a more predictable and uniform degradation pattern, potentially reducing the risk of catastrophic localized failures. Moreover, the partial dissolution of Mg in Fe (as seen from FIG. 4) could influence the electrochemical potential of the alloy, possibly making Fe more electrochemically active. These mechanisms—sacrificial corrosion of Mg, disrupted passivation of Fe, and the altered electrochemical potential of the Fe—Mg solid solution likely all contribute towards increasing the overall degradation rate of Fe—Mg composite.

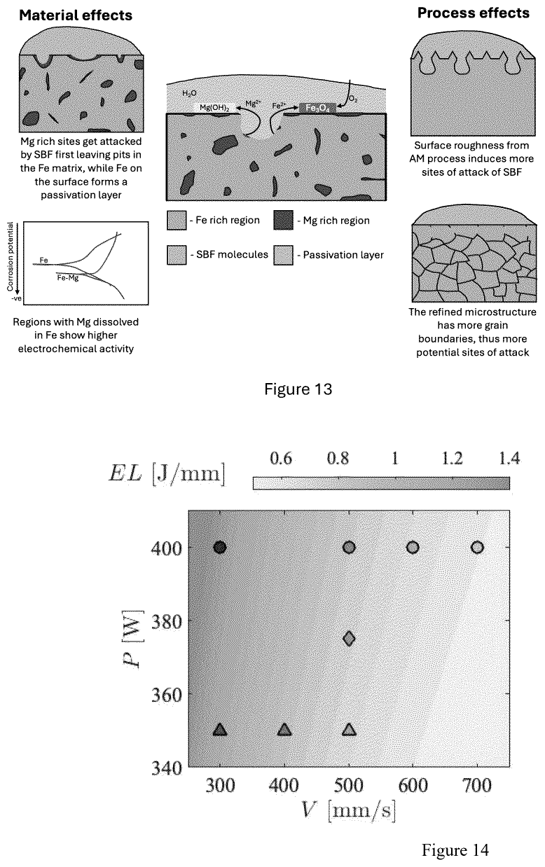

In addition to the contributions garnered by the addition of Mg, factors inherent to AM, such as finer grain size and increased surface roughness, may further accelerate the corrosion kinetics of Fe—Mg composite. Firstly, AM processes often produce materials with much finer grains due to rapid solidification, resulting in a higher density of grain boundaries that act as active sites for corrosion. Prior studies have shown that grain refinement could increase iron's degradation rate from ~0.14 mm/yr to ~0.25 mm/yr. Secondly, the inherent surface roughness of AM parts may also increase the number of corrosion initiation sites, especially in areas where microscopic valleys or peaks can trap SBF, promoting localized reactions. In case of Fe-based implants, the degradation rate has been reported to increase from ~0.05 mm/yr to ~0.1 mm/yr when the surface has been roughened. Since the samples in our study have been immersed in SBF in the as printed state, there could be small contributions towards the overall degradation rate of the Fe—Mg composite. The overall contribution from the AM process can be estimated from FIG. 12 by comparing the degradation rates of cast Fe (first bar in FIG. 12) and DED Fe (control sample in our study shown by the red bar). While we see an increased degradation rate for the Fe sample synthesized using DED, the enhancement in the degradation rate for the Fe—Mg composite is much larger than the potential effects of the AM process alone. We could enhance the degradation rate of pure Fe from ~0.1 mm/yr (DED) to ~1.2 mm/yr for the Fe—Mg composite (DED). The in vitro degradation rate reported in this work surpasses the reported rates in the literature, achieved through various alloying and microstructure control methods. All material and process contributions to the overall enhanced degradation rate of the Fe—Mg composite is shown schematically in FIG. 13.

Other aspects of the present disclosure include enhancing the performance of biodegradable implants by the addition of other elements, materials, and features. For example, magnesium can be added to strengthen the iron matrix and make the implants non-magnetic, thus eliminating interference with MRI machines. Copper can be added to produce antimicrobial properties to the implant. Adding gold can produce antibacterial and antimicrobial properties. Calcium could further promote the osteogenesis of the implants and enhance the formation of hydroxyapatite. Medications requiring delayed release or prolonged delivery could be incorporated into the implants so that the medication would be delivered as the implants degrades. Implants according to aspects of the present disclosure can also take the form of or incorporate lattice structures to act as a scaffold for bone ingrowth.

Certain processes of the present disclosure use additive manufacturing techniques, including powder bed fusion (PBF) with a laser or electron beam as the heat source, and directed energy deposition (DED) with a laser, electron beam, plasma, or other concentrated heat sources, along with powder, wire, and sheet as feedstock as a means to overcome macro segregation during the processing of immiscible materials.

Aspects of the present disclosure also relate to systems other than the Fe—Mg systems discussed above, such as Al—Sn systems. For example in one aspect of the present disclosure, Al—Sn samples were produced via laser powder bed fusion (LPBF). In one aspect, LPBF is utilized to synthesize a single layer Al-50 vol % Sn sample on an Al6065 substrate. Note that although LPBF was carried out on the Al—Sn system, DED can also be utilized. The main characteristic that alters the microstructure between DED and PBF is the scan speed of the concentrated heat source. This directly influences the cooling rate of the process which, is higher in PBF due to higher scanning speeds.

Equal volumetric portions of commercially pure Al and Sn elemental powders (99% purity), with particle sizes of 15-40 μm and 15-30 μm, respectively, were mechanically mixed using a high-energy ball mill (without any media) for 30 minutes. Sheets of Al 6065 alloy were cut to the dimensions of 50 mm×2.7 mm×0.3 mm (length×width×thickness) using electron discharge machining, serving as substrates for the powder bed. The substrate length and height were selected to fit the LPBF setup at the 32-ID-B beamline of Advanced Photon Source (APS) at Argonne National Laboratory, while the substrate thickness was selected to account for X-ray attenuation.

A custom-built laser melting setup, specifically designed for high-speed X-ray imaging at the 32-ID-B beamline of APS was employed for this study. The setup has is detailed at N. D. Parab, C. Zhao, R. Cunningham, L. I. Escano, K. Fezzaa, W. Everhart, A. D. Rollett, L. Chen, T. Sun, Ultrafast X-ray imaging of laser-metal additive manufacturing processes, J. Synchrotron Radiat. 25 (2018) 1467-1477. https://doi.org/10.1107/S1600577518009554. A white beam X-ray with a first harmonic energy of 24.4 keV (λ=0.508 Å) was used, whose window was defined by a pair of slits. The imaging system consisted of a 100 μm-thick LuAG:Ce scintillator, a 45° reflection mirror, a relay lens, an objective lens, and a Photron FastCam SA-Z (USA) high-speed camera.

Each Al substrate was sandwiched between two glassy carbon sheets of 50 mm×2.8 mm to ensure uniform distribution of a 100 μm-thick powder layer. The powder confined by the glassy carbon sheets was melted by a laser beam, replicating single-track printing in LPBF. Both the substrate and chamber were kept at room temperature under an inert argon atmosphere during the experiments.

The laser system consisted of an ytterbium fiber laser and a galvanometer laser scanner. A continuous-wave laser beam with a Gaussian beam profile, a wavelength of 1,070 nm, and a maximum power of 520 W was utilized. The Gaussian beam diameter is defined as the position where the irradiance reaches 1/e² (13.5%) of its maximum value, and it was ~45 μm at the laser waist. The beam was defocused to a diameter of ~95 μm at the working plane.

The powder sample and holder were placed inside a stainless-steel vacuum chamber equipped with a fused silica window to allow laser entry. X-ray beams entered and exited the chamber through two Kapton windows positioned on either side of the substrate. Sample, laser, and X-ray alignments were achieved using stepper motors.

Laser processing parameters, including P and V, are presented in FIG. 14 as a processing map. The symbols in this map are color-coded by linear energy density (EL=P/V, J/mm), ranging from yellow for the lowest values to purple for the highest. The symbols and colors representing each set of laser parameters are consistent throughout this disclosure. Individual data points in FIG. 14 are detailed in Table 2.

TABLE 2
Laser power (P), scanning speed (V) and linear energy density (EL = P/V).

| P (W) | 350 | 350 | 350 | 375 | 400 | 400 | 400 | 400 |
|---|---|---|---|---|---|---|---|---|
| V (mm/s) | 300 | 400 | 500 | 500 | 300 | 500 | 600 | 700 |
| EL (J/mm) | 1.17 | 0.88 | 0.70 | 1.25 | 1.33 | 0.80 | 0.67 | 0.57 |

The synchrotron images were the integrated attenuations along the optical path, where the packed powder bed in the fore- or background and surface contamination on side walls were superimposed on the melt flow features of interest. Therefore, there were slow moving features (contaminations, fore- or background) which were removed to distinguish the actual actions in the melt pool specifically for velocity field measurement. At each time instance, the slow-moving background was approximated by the median of a stack of 10 neighboring frames, and it was then subtracted from the original image to better reveal the fast-moving melt flow feature. For the intensity measurement concerning Al and Sn distribution in the melt pool discussed below, this correction made for velocity analysis was not applied.

The velocity of the melt flow was calculated from the image sequence by tracking the contrast features created by the density difference in Al and Sn liquids, using a processing technique similar to that of Particle Image Velocimetry (PIV). The method employs an image pair taken at a known time separation in between. The images are first divided into a grid of templates (‘interrogation windows’), and cross-correlation is performed between the corresponding interrogation windows in the first and second image. The displacement of the features between the two images can be derived from the location of the peak in the cross-correlation coefficient and converted to velocity using the time separation. The major difference between the synchrotron images carried out and conventional PIV images was that here the flow was not visualized through tracer particles, but the contrasts in the density field.

The images were processed in MATLAB using the OpenPIV code package. An interrogation window size of 24×24 pixels (48×48 μm²) with 67% overlap in both directions was selected. The interrogation window size limited the processing algorithm's ability to capture eddies smaller than 48 μm, but the measurements of larger-scale motions were reliable.

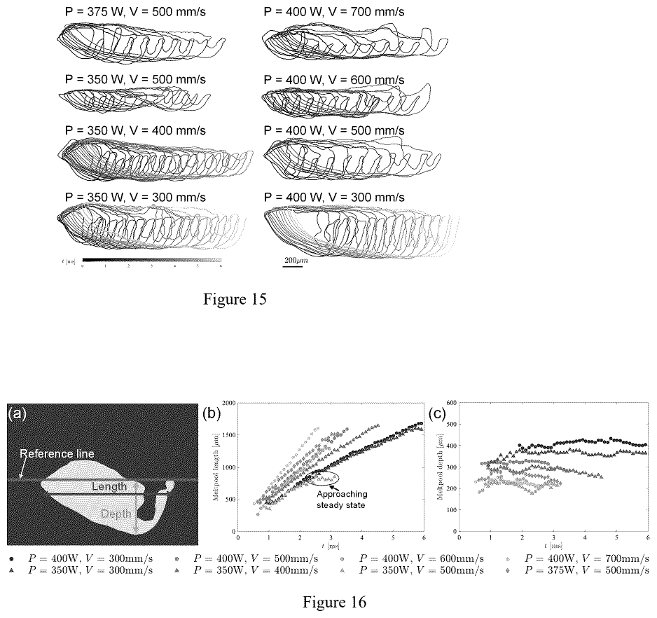

To statistically analyze the morphology of melt pools and vapor depression, the boundaries of the melt pools were outlined for various processing parameters as shown in FIG. 15. Since the depth-to-half width ratio of the vapor depression was well above 1 in the majority of cases, it will be referred to as a keyhole unless otherwise indicated. In particular, FIG. 15 shows the changes in the melt pools from the beginning of the melting (purple, t=0 is when the laser beam is switched on) until the end of the experiments (yellow).

FIG. 16(a) illustrates the definition of melt pool depth and length. The reference line for these measurements was set at half the thickness of the powder layer from the substrate, with the depth measured from the deepest point to the reference line, and length defined as the distance between the two ends of the melt pool. Based on these definitions, the melt pool length and depth were extracted from the melt pool boundaries (FIG. 15) as a function of time (t), as plotted in FIGS. 16(b) and (c), respectively. Melt pool depth did not show significant changes over time, but as expected, increased with increasing the energy input from ~200 μm to ~400 μm. In contrast, the length increased almost linearly with time for all processing conditions from ~400 μm to ~1,600 μm, except for the case of V=500 mm/s and P=350 W. In the latter, the length of the melt pool reached a steady state (constant length of ~800 μm) after ~2.5 ms. This is attributed to the balance between the laser scanning speed and the speed of the solidification front along the laser beam direction.

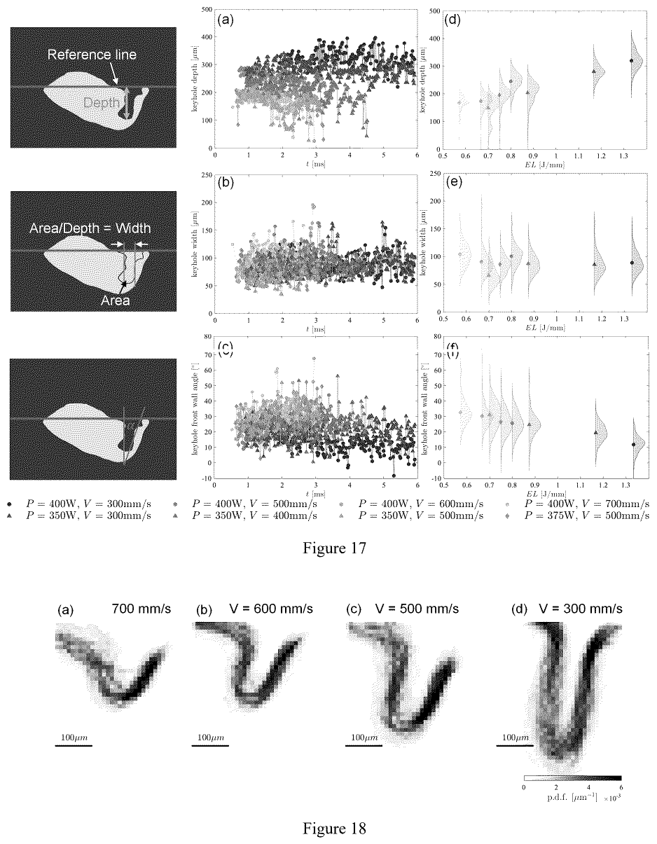

To understand the instability of the melt pool as a whole, it is useful to analyze the instability and dimensional changes of the keyhole with time during laser scanning using different V and P values (FIG. 14 and Table 2). The left column in FIG. 17 shows the definition of keyhole depth, keyhole front wall angle (α), and width (the measured keyhole area divided by the depth). FIGS. 17(a)-(c) present the time series of keyhole depth, width and a over the period of the experiments, respectively. FIGS. 17(d)-(f) show the violin plots corresponding to the data in FIGS. 17(a)-(c), depicting the mean values (symbols in the plots) and the distributions of keyhole depth, width and a for different EL (different laser parameters). The results show an increasing trend in the depth with increasing EL from just below 200 μm to ~400 μm, while the width remains almost unchanged at ~100 μm. In addition, multiple peaks appear for EL <~0.9 J/mm in FIGS. 17(d)-(e), indicating less consistency in the geometries of the keyhole, whereas a typical Gaussian distribution with one major peak is seen for higher values of EL. This inconsistency is ascribed to the fact that at lower energies, there are occasions when vapor depression switches between various modes of keyhole, namely transition and conduction. In other words, at a higher energy density, the keyhole depth and width undergo less changes. The front wall angle α in FIG. 17(f) also shows narrower distribution with smaller mean values for higher EL, indicating a more stable and more vertical keyhole, in agreement with the literature.

The instability of the keyhole was further examined by calculating probability density function (p.d.f.) maps for keyholes with different morphologies, as typified in FIG. 18 for a fixed P of 400 W and different V of 300-700 mm/s. The darker regions represent areas where the keyhole walls are most likely located, indicating greater stability with fewer changes, while lighter colors indicate greater instability, where the keyhole walls frequently shift positions. In all cases, the front wall remains relatively stable, while the rear wall is the most unstable. In the deep keyhole formed at V=300 mm/s, the instability can also be seen at the bottom of the keyhole, since the laser beam makes a smaller angle relative to the walls of such a vertical keyhole, leading to more direct exposure of the keyhole's bottom to the laser, and as a result, more vaporization there as compared to the keyholes with larger a.

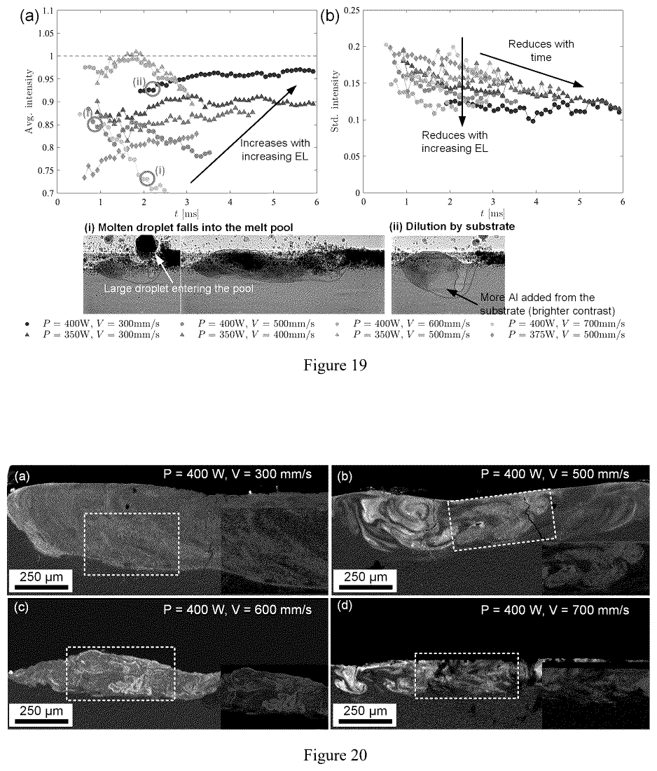

The intensity (brightness) of the X-ray images within the studied melt pools provides insight into the distribution of Al and Sn in them in real time. Statistical analysis of the intensity measurements is shown in FIG. 19. In this figure, a higher intensity refers to higher brightness from a liquid within the melt pool, which indicates a higher concentration of Al and lower amount of Sn. As seen in FIG. 19(a) (note that only every fifth data point is shown for clarity), several phenomena can change the intensity: (i) large spatters/liquid droplets entering the melt pool, suddenly injecting a large amount of unmixed Sn-rich melt in the pool, causing low intensity, and (ii) dilution of the melt pool due to the addition of Al from the substrate, resulting in greater brightness. It is worth mentioning that there are cases with an intensity near unity, which belong to cases where EL is too low to melt enough powder in the laser track (most powder blows away because of lack of sintering and melting), and most intensity comes from a very thin laser track predominantly from melting the AI-based substrate.

Standard deviations of the intensity data are plotted in FIG. 19(b), showing that the variation in the intensity reduces with time and EL. This suggests that the intensity, and thus distribution of Al and Sn, becomes more uniform when the elemental ingredients have more time to mix, and the mixing rate is accelerated at higher EL. Comparing FIG. 19(a) and FIG. 16(c) reveals a strong correlation between the intensity and the melt pool depth, so that a higher intensity is obtained for deeper melt pools. This indicates that the dilution by adding Al from the substrate can play an important role in the composition of the laser track.

This observation is further supported by SEM micrographs of the laser tracks in FIGS. 20(a)-(d), showing the distribution of Al and Sn—note that Sn is seen bright and Al dark in the backscattered electron microscopy due to the higher atomic number of Sn. The Sn elemental map from the boxed area in the laser track for each case is also shown as an inset. It is clearly seen that in the deeper melt pool (P=400 W, V=300 mm/s) Sn is more uniformly distributed with much less contrasts (FIG. 20(a)). On the contrary, in shallower melt pools produced at V≥500 mm/s, as shown in FIGS. 20(b)-(d), a more pronounced presence of Sn layers is observable, which are much less uniformly distributed compared to the deeper melt pool in FIG. 20(a). This heterogeneity appears to increase with increasing V. This demonstrates more dilution and more interaction between Al and Sn in the deep pool, preventing such substantial segregation and heterogeneity seen in the other cases. Additionally, the re-entrance of droplets into the laser tracks at higher speeds appears to be another important factor contributing to sudden changes in Sn distribution. This effect is particularly evident in FIG. 20(c), where distinct changes in Sn distribution can be observed due to this phenomenon.

Heterogeneity and distribution of Sn and Al were further quantified by measuring the averaged distance between an Sn-rich region/particle from its 5 nearest neighbors (d̅) throughout the laser track for two cases: V=300 mm/s and V=500 mm/s, at a constant P=400 W. Overall, the averaged distance d̅ is on the order of 1 μm for both cases. However, the V=500 mm/s case has a broader distribution of d̅, with a larger standard deviation (d̅_{std}) of ~0.8 μm, compared to d̅_{std} of 0.3 μm for V=300 mm/s. This indicates a more heterogeneous distribution of Sn in Al at V=500 mm/s.

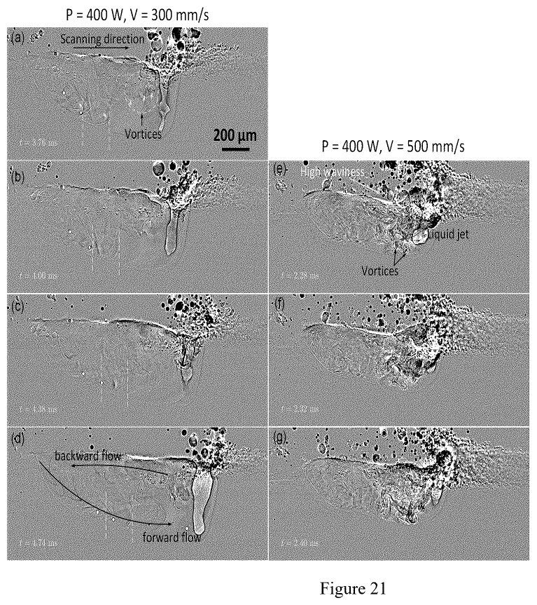

FIGS. 21(a)-(d) show a series of frames from melt pools at P=400 W and V=300 mm/s. In these frames, Sn as the heavier element is seen darker (selectively arrowed in FIG. 21(a)). By visually tracing the bright (Al) and dark (Sn) contrasts, the overall outward melt circulation pattern is observed, as shown in FIG. 21(d) Close to the keyhole, the melt flow is more unstable, so that a few vortices are formed (circled in FIG. 21(a)). As the flow reaches the rear of the melt pool, the forward flow pushes the Sn layers forward, as indicated by the forward displacement of two markers (vertical dashed lines). Overall, the flow pattern in FIG. 21(d) represents a typical outward flow likely dominated by Marangoni forces.

FIGS. 21(e)-(g) present consecutive frames captured from melt pools at a higher V of 500 mm/s, and the same P of 400 W. The contrast between the bright and dark areas, representing Al and Sn elements respectively, is much more pronounced than in FIGS. 21(a)-(d), indicating increased segregation. This is consistent with the observations in FIG. 20. Unlike the stable melt pools in FIGS. 21(a)-(d), the melt pools in FIGS. 21(e)-(g) exhibit greater instability with larger surface waviness. Further, the backward motion of the keyhole generates strong jets, which lead to the formation of numerous small vortices (outlined by dashed lines). As these vortices reach the bottom of the melt pool, forward and backward flows develop, causing the layers of Sn and Al to spread.

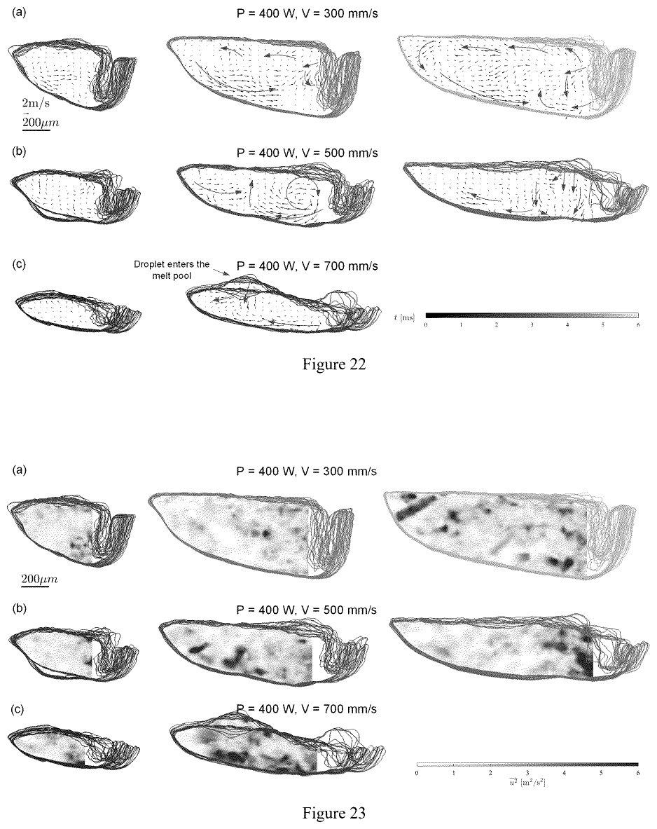

FIGS. 22(a)-(c) show the averaged velocity fields over 20 frames (corresponding to 0.4 ms), covering times ranging from ~2 to 4 ms (with time color-coded) for a constant P of 400 W and different V of 300, 500 and 700 mm/s, respectively. Since the velocity field analysis represents an average, it results in a 2D representation of the flow field. Caution should be exercised when comparing this to real scenarios, as the out-of-plane motions and the variation of velocity along the width of the melt pool in 3D cases is not captured. The melt pool boundaries were aligned so that their tails were overlaid, to ensure a good representation of the flow pattern at the tail of the melt pool. The horizontal shift of the melt pools is typically less than a few percents of the melt pool length. Overall patterns of melt flow are indicated by red arrows. The melt pools can be distinguished by their morphology: FIG. 22(a) displays a deep, vertical keyhole for P=400 W and V=300 mm/s, while FIGS. 22(b)-(c) depict shallower melt pools and keyholes with more surface oscillations for lower P and/or V settings. The surface roughness of the pools for these cases was estimated by measuring standard deviation of surface height (Rq) in each frame. The average values (Rq, avg.) over time were ~20 μm for V=300 mm/s, ~25 μm for V=500 mm/s, and ~35 μm for V=700 mm/s. Note that these are average values, and in the last two cases, Rq could reach maximum values of 50 μm and 60 μm, respectively, while it remained below ~30 μm for V=300 mm/s.

In FIG. 22(a), the melt at the top of the melt pool consistently flows from the keyhole toward the back of the melt pool near the surface, while in the lower region, closer to the melt/substrate interface, the flow generally moves forward from the tail toward the keyhole. At the early stage of melt pool formation, when the pool is still developing, a distinct roll-up of the melt is observed (left panel, FIG. 22(a)). As the pool stabilizes and deepens, the flow pattern becomes more consistent, with forward motion at the bottom and backward motion at the top (i.e., outward circulation most likely dominated by Marangoni forces). However, very close to the keyhole, the melt is pushed back and forward, following the oscillation pattern of the keyhole. In the right panel of FIG. 22(a), it is also seen that the melt jets backward at the bottom of the melt pool, moving in the opposite direction of the forward flow. The collision of these two flows results in a small roll-up.

In contrast, FIGS. 22(b)-(c) show that in shallower melt pools (resulted from lower energy inputs), the outward flow seen in FIG. 22(a) is no longer observed. Instead, strong liquid jets reversed the flow backward in a large portion of the melt pools. These jets are a consequence of keyhole instability and recoil pressure. Although such a liquid jet is also seen in the deeper melt pool (right panel, FIG. 22(a)), its strength is not as great as those formed at higher V of ≥500 mm/s. As a result, it only affects the flow near the keyhole at V=300 mm/s (deeper pool), whereas at ≥500 mm/s (shallower pool), almost the entire melt pool is affected. This can be attributed to, first, more effective absorption of inertial forces from recoil pressure in the deeper melt pool due to a larger volume of the melt, and second, the differences in the angle of the keyhole front wall in different cases. The liquid jet in FIG. 22(b) (middle panel), can also result in a large inward flow, moving in an entirely different direction from the flow in FIG. 22(a). However, the rebound of the melt at the melt pool's tail can still lead to forward flow (middle panel, FIG. 22(b)). Again, the collision of the forward flow from the rebound and the backward flow from the liquid jet gives rise to a roll-up.

Shallower melt pools also show a higher degree of waviness, which can influence the flow pattern. The right panel in FIG. 22(b) shows a wave close to the keyhole, creating a downward motion (indicated by red arrows). When the melt impacts the bottom of the melt pool, the melt spreads forward and backward. At a higher V of 700 mm/s, the waviness is even greater, and similarly the motion of the waves dictates the flow direction (right panel, FIG. 22(c)). The waves can be a result of the liquid jets, keyhole instability, and large spatters/droplets falling into the laser track. In the specific case in FIG. 22(c), the impact from a droplet results in waviness and downward flow in the melt pool. As shown in FIGS. 18(a)-(c), the rear wall of the keyhole is the most unstable, and its backward movement pushes the melt, generating waves. Although FIG. 18(d) also shows a similar instability, such large waves are not formed at V=300 mm/s and P=400 W. It is worth mentioning that whether the flow stemmed from Marangoni forces or inertial forces, the flow velocity was mainly in the range of 1-2 m/s.

Since liquid jets result in backward flow in most cases, it is worth to analyze their role in changing the flow velocity in the x direction (horizontal, u). The u-velocity fluctuations across 20 frames, corresponding to the vectors in FIG. 22, are shown in FIG. 23. These figures clearly demonstrate that the liquid jets result in significant fluctuations within the melt pools. In FIG. 23(a), for the deeper melt pools at P=400 W and V=300 mm/s, the fluctuations are relatively low. However, as the energy input decreases (higher V), the fluctuations increase significantly, reaching their peak at P=400 W and V=700 mm/s, particularly near the keyhole, at the bottom of the melt pool, and regions with pronounced surface oscillations (FIGS. 22(b)-(c)).

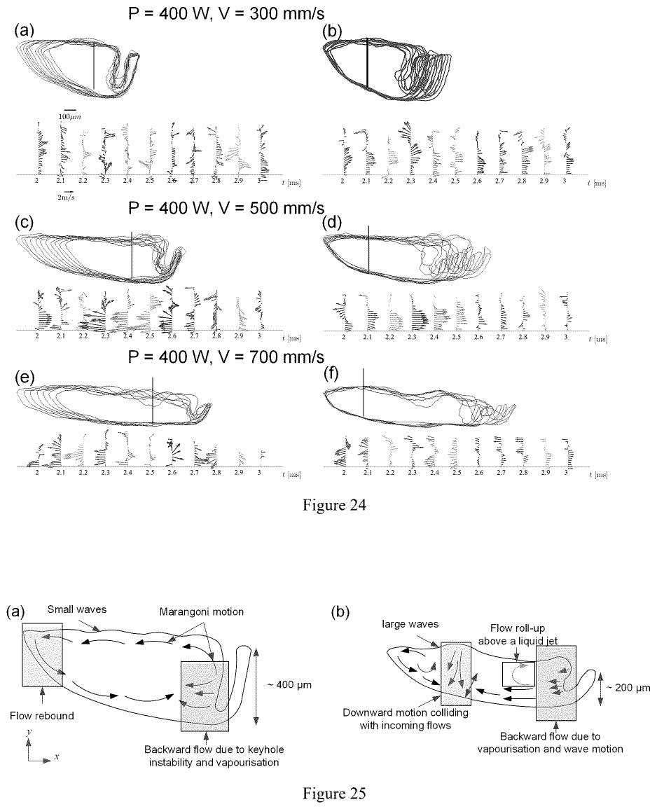

To better understand the role of keyhole instability and melt pool morphology in melt flow and mixing, the velocity profiles from the top to the bottom of the melt pool were obtained at different times from two sections: one at a fixed distance to the keyhole and another further back in the melt pool, at a fixed distance to the tail, as marked by the vertical solid lines on melt pools in FIG. 24. The velocity vectors along each of these two sections are shown for different time instances (x-axis) at the bottom of the corresponding melt pool. The data obtained from melt pools at a constant P=400 W and different V=300-700 mm/s are shown in FIGS. 24(a-b) for V=300 mm/s, FIGS. 24(c-d) for V=500 mm/s and, FIGS. 24(e-f) for V=700 mm/s.

FIG. 34(a) reveals that near the keyhole, the velocity vectors are unsteady and randomly oriented over time, likely due to significant instability along the keyhole (see FIG. 18(d)). In contrast, FIG. 24(b) shows that farther away from the keyhole, the velocity vectors consistently point in the forward direction throughout the experiment, which aligns with observations in FIG. 22(a).

At 500 mm/s, a strong backward flow near keyhole is observed (t=2.1-2.7 ms in FIG. 24(c)), potentially resulted from a liquid jet, although forward flows, for instance at t=2 and 2.8-3 ms, are also observable. At the rear of the melt pool, the flow remains mainly forward (FIG. 24(d)), possibly due to rebound from the melt pool's rear wall. The flow at 700 mm/s was the most chaotic, with consistent changes in flow direction over time in both studied sections (FIGS. 24(e)-(f)). This is likely caused by larger waves and liquid jets, which influence the motion throughout the melt pool, including the tail.

The use of Sn and Al, two elements with significantly different X-ray attenuation due to their density differences, enabled the tracking of melt flow across various combinations of power and scanning speeds. The melt flow pattern could be influenced by a number of factors, such as melt pool instability and Marangoni motion.

The flow pattern and velocity can stem from a combination of forces, including inertial forces (e.g., liquid waves on the melt pool surface, keyhole instability, vaporization) and Marangoni motion. FIG. 25: a deep melt pool with a smoother surface (FIG. 25(a)), resembling the melt pools formed at P=400 W and V=300 mm/s (FIG. 15), and a shallow melt pool with lower energy input at higher V (FIG. 22(b)), similar to the melt pools at P=400 W and V=700 mm/s (FIG. 22(c)). However, FIG. 25 is based on the flow field analysis is a 2D model because the calculated flow velocity is an average across the width of the melt pool, while in actual scenario some motions can have different speeds across the width.

Vaporization in the keyhole creates two simultaneous effects: the unsteady recoil pressure pumps the liquid around the keyhole, and the upward plume of metallic vapor escaping from the depression zone drives the melt flow upwards at the plume/melt interface of the keyhole, due to interfacial friction. Additionally, the instability and movement of the keyhole during processing (as shown in FIG. 18) alters the position and pattern of these forces. For instance, when the keyhole expands or its rear wall is pushed backward, the adjacent melt is also forced backward. This effect is observed in both the schematics in FIG. 25 and the experimental results in FIG. 22. These instabilities contribute to velocity fluctuations near the keyhole and liquid jets, as depicted in FIGS. 23-24. Several mechanisms have been proposed by others for the keyhole instability and oscillation, such as laser beam reflection within the keyhole, leading to localized vaporization, variations in powder packing density affecting metal vapor generation, and laser blockage by additional material at the keyhole opening. Among these, the laser reflection mechanism is likely the most relevant in the present context, as it explains the significant oscillation of the rear wall (FIG. 18). The high waviness of the shallow melt pools (FIG. 22(b)) can also contribute to the blockage of the laser beam, consistent with the last mechanism proposed for keyhole instability. The mechanism related to the powder packing density is less relevant as it was proposed for a multiple-layer LPBF process, which differs from the present disclosure.

In the deep melt pool (FIG. 25(a) and experimentally observed in FIG. 22(a)), there is a consistent outward flow: the melt in the upper part of the pool moves backward toward the tail and then rebounds forward from the tail to the keyhole. This uniform outward flow suggests the influence of the Marangoni effect, where liquid moves from the hotter region (around the keyhole) toward cooler areas (toward the tail) on the surface. The surface tension for both Al and Sn decreases with temperature, driving a flow from the low surface tension region (keyhole) toward the higher surface tension zone (tail). However, near the keyhole, the flow direction is more influenced by the keyhole's oscillations, leading to small liquid jets, backward and occasional forward motions (FIGS. 25(a), 22(a), and 24(a)).

In contrast, the shallow melt pool (FIG. 25(b)) does not exhibit this uniform outward circulation. Instead, large waviness and significant velocity fluctuations, driven by inertial forces particularly from recoil pressure (as seen in FIG. 23), are dominant. This highlights that the instability in the melt pool, caused by vaporization and surface waves, is strong enough to overcome surface tension forces, forcing the flow to follow the direction dictated by these inertial motions.

Two factors can be considered to explain the higher waviness in the shallower pools compared to the deep ones. First, in the shallower pools, the keyhole is tilted at larger a angles, allowing the recoil pressure to push the melt horizontally (along the x-axis) with little resistance from the bottom wall of the melt pool. This results in the strong liquid jets observed in FIGS. 22 and 23. In contrast, when the keyhole is more vertical (small a in the deeper pools), the liquid jet is mostly pushed downwards, where its energy can be significantly absorbed by the bottom wall of the pool. This may explain why the deep melt pool exhibited smaller liquid jets confined to the vicinity of the keyhole. This argument can further be supported by the keyhole instability analysis in FIG. 18, showing contraction and expansion of the keyhole (instability) along the vertical axis (FIG. 18(d)), which could cause downward flow, as well as backward at that particular location. In comparison, FIGS. 18(a)-(c) show that the instability of the keyhole mostly occurs horizontally (i.e., along the direction of the rear wall expansion and contraction).

Second, the shallow pools contain a smaller volume of the melt, which is less capable of absorbing and damping the momentum from inertial forces as compared to the larger melt volume in deeper pools. The melt pool instability is further exacerbated when wave-driven flows collide with the surrounding melt. For instance, FIG. 25(b) shows that a downward flow generated from a wave meets with a backward flow from the keyhole and a forward flow from the rebounding liquid at the pool's tail, resulting in upward and/or downward motion (indicated by double-headed red arrows). When the downward flow does not interact with other flows, it strikes the bottom of the melt pool, causing the flow to spread along the bottom. Furthermore, the fast-moving melt in strong liquid jets, surrounded by slower melt in the shallow pools, generates an inward flow roller (FIGS. 25(b) and 22(b)). Hence, not all circular motions are a result of the Marangoni effect.

FIGS. 19 and 20 clearly show a higher degree of dilution in the deeper melt pool formed at a slower V of 300 mm/s compared to shallower ones at V≥500 mm/s. These figures demonstrate more uniform distribution of Al and Sn in the deep pool. These observations can be attributed to several factors. The greater energy input and relatively reduced cooling rate at lower V promote the interaction between Al and Sn, initially mixed as separate elemental powders, in the liquid state for a longer time. This allows for the formation of a more compositionally uniform liquid, subsequently leading to a more uniform distribution of Al and Sn in the microstructure after solidification. This is particularly evidenced in FIG. 19(b) where the fluctuation in concentration decreases with increasing time. Moreover, the composition of the melt is altered due to the dilution effect from the AlSi 10Mg substrate, adding more Al into the deep melt pool because of the deeper keyhole (see dimensions in FIG. 17(a)). Another factor is the greater waviness of the shallower pools, which leads to the formation of large spatters/liquid droplets. These droplets can re-enter the melt pool (e.g., FIG. 19(a)), and consequently, bring about sudden compositional changes locally. This could further contribute to the heterogeneous distribution of Sn and Al. Finally, the consistent flow in the deeper melt pool enables a relatively prolonged mixing process in the entire melt pool compared to the shallower pools, where the mixing is inconsistent and spatially uneven (e.g., changes in vaporization modes, a fast-moving liquid jet in one location, and slow motion in another, large wave in one point and smoother flow in another). These combined factors affect the dilution and create the nonuniform distribution of Sn-rich and Al-rich layers in the shallower melt pools, while these layers, although still exist, are more uniformly distributed in the deeper pool.

Additionally, there are more micro-vortices in the shallower melt pool compared to the deeper one. This can be attributed to significantly nonuniform velocity fluctuations and strong liquid jets in the shallower melt pool. Vortices typically arise from velocity differences between layers of liquid, which create shearing forces between these layers. As depicted in FIG. 23, liquid jets from keyholes and surface waves induce high-speed flows with significant fluctuations. In contrast, the surrounding liquid experiences less velocity changes. This discrepancy results in regions within the melt pool where the flow velocity gradient is large, leading to the formation of micro-vortices.

Numerical and computational models have shown that the Marangoni effect, which refers to the flow of liquid due to surface tension gradients, may play a key role in melt pool dynamics. Surface tension gradients can arise from either temperature or composition gradient. Ignoring the localized powder-particle scale composition variation, and assuming the liquid composition remains homogeneous in the melt pool scale, the strong thermal gradient within the melt pool is likely the source of the Marangoni effect. Since the surface tension of both Al and Sn decreases with increasing temperature, the liquid is expected to flow from the high-temperature region near the keyhole to the cooler rear end of the melt pool, potentially contributing to the backward flows indicated in the upper melt pool region in FIG. 25(a). The strength of the Marangoni effect can be quantified using the thermal Marangoni number (Ma), which is essentially the ratio of Marangoni forces to viscous forces, defined as:

$$Ma = - ( \frac{d σ}{dT} ) \cdot \frac{L Δ T}{{µα}_{T}}$$

where d σ/dT is the surface tension (σ) gradient with temperature (surface tension coefficient), L is characteristic length scale (melt pool length), ΔT=T_{b}−Tₘ the difference between boiling temperature (T_{b}) and melting temperature (Tₘ), μ dynamic viscosity of the liquid, and α_{T} thermal diffusivity of the liquid. Table 2 presents the parameters used and the calculated Ma values for pure Al, pure Sn, and Al-50Sn liquids. Based on the melt pool length shown in FIG. 16, which ranged from 400 to 1,600 μm as the laser beam progressed, the characteristic length L used in the Ma calculation is also considered to be 400-1,600 μm. Because most physical properties of Al-50Sn are unavailable, the rule of mixture is applied to roughly estimate them based on the properties of the pure elements. Note that while the rule of mixture may not be highly accurate, the goal here is to stay within the correct order of magnitude. Therefore, for rough estimations, this approach is considered reasonable. The resulting Ma values of >4,000 and >6,000 suggest that the Marangoni forces are much stronger than the viscous forces and can potentially play a substantial role in transferring the hotter liquid from the keyhole to the cooler regions of the melt pool.

TABLE 3
Marangoni number in a temperature range of 933-1200 K (above Al melting temperature)
and the parameters required for its calculation as per eq. above for pure Al
and Sn, and Al-50Sn liquids.

| Liquid | $\frac{d σ}{dT} ( N / mK ) \times {10}^{- 4}$ | T_{b} (K) | Tₘ (K) | μ (Pa · s) × 10⁻³ | a_{T} (m²/s) × 10⁻⁵ | Ma × 10³ |
|---|---|---|---|---|---|---|
| A1 | −3.5^{[51]} | 2,743^{[54]} | 933^{[51]} | ~0.8 at 1200 K | 3.3 at 933 K | > 6 |
| | | | | ~1.3 at 933 K^{[55]} | 4.1 at 1200 K^{[56]} | |
| Sn | −0.9^{[51]} | 2,893^{[54]} | \|505^{[51]} | ~0.8 at 1200 K | 2.1 at 933 K | > 4 |
| | | | | 1 at 933 K^{[57]} | 2.2 at 1200 K^{b} | |
| Al-50Snª | −-2.2 | 2,818 | 719 | 0.8 at 1200 K | 2.7 at 933 K | > 6 |
| | | | | 1.15 at 933 K | 3.15 at 1200 K | |

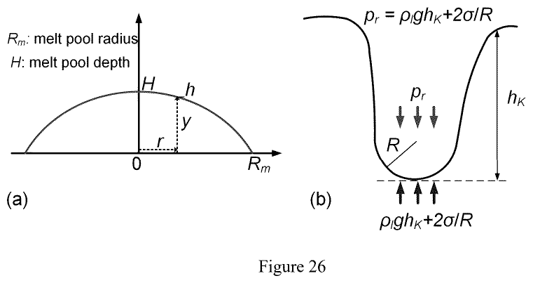

To understand the significance of the Marangoni effect in the melt flow, its contribution to the flow recirculation velocity is assessed. We model the melt pool as an axis-symmetric spherical cap with a radius of Rₘ and a height of H, as schematically shown in FIG. 16(a). The radial velocity can be expressed as

$${U}_{r} = - \frac{1}{2} [ \frac{y}{h} - \frac{3}{2} {( \frac{y}{h} )}^{2} ] \frac{h}{µ} \frac{d σ}{dT} \frac{dT}{dr}$$

where y is the local wall normal height with y=0 at the melt pool bottom, and y=h at the free surface. From the tail of the melt pool to the center, h varies from 0 to H. From this formula, it is clear that the velocity profile follows a parabolic shape (FIG. 26), with the vertex located at the bottom ⅓ of the melt pool. The Marangoni circulation velocity is estimated as the vertex value of the parabola:

$${U}_{m} = \vert - \frac{1}{12} \frac{h}{µ} \frac{d σ}{dT} \frac{dT}{dr}$$

Assuming a temperature gradient of dT/dr≈ΔT/L≈1×10⁶ K/m, and using the liquid properties from the rule of mixture (dσ/dr=−2.2×10⁻⁴ N/m, μ=1×10⁻³ Pa·s), and H=4×10⁻⁴ m, the Marangoni circulation velocity is found as Uₘ≈7 m/s, which is in the same order as the experimental observations (see FIG. 22, for example). The analytical solution shows that Uₘ is proportional to the depth of the melt pool, indicating a reduction in the intensity of the Marangoni-driven circulation for cases with a lower energy input.

It is important to note, however, that several assumptions were made in the derivation of this velocity scale. The axis-symmetric assumption deviates from the actual geometry of the melt pool, the influence of the velocity fluctuations of flow is neglected, and the temperature gradient is also an approximation. In reality, the temperature gradient is steeper near the keyhole and becomes more gradual toward the tail of the melt pool. If the local temperature gradient is greater or less than the assumed value, the velocity will also vary accordingly. Given the assumptions that leads to overestimations, these estimates should be viewed as order-of-magnitude approximations, indicating that the Marangoni effect is a major contributor to a flow velocity on the order of 1 m/s. Similar to our observations, this range of velocity has previously reported for an Al alloy with W tracers.

We consider an idealized model of a stationary keyhole, which has a hemispherical cap with a radius of R, as schematically illustrated in FIG. 26(b). Balancing the recoil pressure with the hydrostatic pressure and Laplace pressure at the tip of the keyhole, the recoil pressure can be expressed as

$${p}_{r} = {ρ}_{l} {ℊ h}_{K} + \frac{2 σ}{R}$$

where the first term on the right side of the above formula is [symbol] pressure, and the second one is Laplace pressure. Assuming a keyhole depth hK=200 μm and radius R=40 μm (measured from keyholes in FIG. 15), liquid density ρl=4.68 g/cm³ (from the rule of mixture, using ρ_{Al,T}=2.38 g/cm³ [61] and ρ_{Sn,T}_{ₘ}=6.98 g/cm [62]), g=9.81 m/s, and σ=0.78 N/m, the recoil pressure is estimated to be pᵣ~40 kPa. Note that the first term in the formula above proportional to the keyhole size, whereas the second term is inversely proportional to it.

Therefore, at such a small keyhole scale, the recoil pressure is predominantly contributed by the Laplace pressure term. The calculated result is close to the commonly accepted value, which is around 0.54 times of the saturated vapor pressure.

Given that the metal plume reaches its stagnation point at the tip of the keyhole, where the recoil pressure is computed, the plume velocity (Ug) can be estimated from Bernoulli's principle:

$${p}_{r} = \frac{1}{2} {ρ}_{ℊ} {U}_{ℊ}^{2}$$

where ρg=0.5 kg/m³ is the density of the mixture vapor plume (gas) estimated using the ideal gas law at 3000 K, resulting in a plume velocity of Ug≈400 m/s.

To estimate the strength of recoil pressure fluctuations, we consider a ±10 μm variation in R, in accordance with the measured standard deviation of the keyhole tip radius (not shown here). Repeating the calculation, the recoil pressure difference between the higher and lower ends of R is found to be ~20 kPa. If the momentum associated with this pressure difference is completely transferred to the melt, it will generate a liquid velocity of Uᵣ=j2Δpᵣ/ρₗ≈3 m/s, which is in line with the experimental observation (see FIG. 22, for example). Since this velocity is on the same order as the Marangoni-driven velocity, it is difficult to determine which force is the larger contributor to the flow velocity, but both clearly play significant roles. However, experimental observations suggest that vapor pressure and keyhole oscillations can generate inertial forces that move the surrounding melt more strongly. This indicates that recoil pressure may play a more dominant role close to the keyhole when vaporization leads to large inertial forces.

The buoyancy effect in the Al—Sn system arises from the density difference between Al and Sn, which could potentially lead to sedimentation if it overcomes other forces such as the Marangoni effect and vapor pressure. To evaluate this, the settling velocity (Uset) of liquid Sn in liquid Al is estimated using:

$${U}_{set} = \sqrt{\frac{( {ρ}_{Sn} - {ρ}_{Al}}{{ρ}_{Al}}} gH$$

where ρ_{Sn} and ρ_{Al} are densities of liquid Sn and Al (ρ_{Al,T}_{ₘ}=2.38 [61] and ρ_{Sn,T}_{ₘ}=6.98 g/cm), g=9.81 m/s² is the gravitational acceleration, and H=200-400 μm is the melt pool depth (see FIG. 16(b)). This calculation assumes that Sn is settling within a melt pool of Al and excludes other forces. The estimated Uset ranges from 0.06 to 0.09 m/s, significantly lower compared to the flow velocities driven by the other factors, which are on the order of 1 m/s—two orders of magnitude larger than the buoyancy-driven velocity.

In summary, vapor pressure and Marangoni forces contribute most significantly to the melt flow, as their estimated velocities (on the order of 1 m/s) align with the experimentally observed values. However, experimental observations also indicated that when strong oscillations in the melt pool walls or surface waves occur, the flow tends to follow the directions dictated by these forces. Further, from deep to shallow melt pools, the vapor pressure pushes the liquid more horizontally due to larger a angles, leading to stronger liquid jets and more waviness. The velocity estimates, particularly for the Marangoni effect, may be overestimated, because of the strong assumptions made, while in practice, its influence could be weaker than that of inertial forces and vapor pressure. Thus, combining these velocity scale estimations with real experimental observations suggests that although the Marangoni effect can influence the flow, especially in deeper melt pools where outward circulation is evident, its role diminishes when inertial forces are dominant. Lastly, buoyancy appears to contribute the least to melt flow, as the significantly lower settling velocity is negligible compared to the melt velocities driven by other forces.

It should be noted that the analysis above were based on observation before reaching the steady-state condition, where the melt pool geometry is constant over time. In the steady-state condition, several differences would likely be observed, including reduced temporal fluctuations in fluid velocities, elongated melt pools, and extended mixing times, all of which can influence the degree of mixing between Al and Sn.

The increased waviness and instability observed in shallow melt pools at higher scanning speeds can be evaluated using the Weber number (We), which represents the ratio of inertial forces to surface tension forces:

$$We = \frac{{ρ}_{{l}^{U} {f}^{2} L}}{σ}$$

where Uf is the flow velocity and the remaining parameters are as previously defined. When We >1, the liquid inertial forces dominate over surface tension, while for We<1, surface tension forces are more significant in the flow.

In the system of the present disclosure, which consists of nearly pure Al and Sn, we assume that both metals are fully melted. Given that the melting point of Al is higher than that of Sn, the parameters in the above formula are calculated at the melting point of Al, where both elements are in the liquid state. Specifically, for calculations, we use ρ_{Al}=2,375 kg/m³, ρ_{Sn}=6,699 kg/m³, and L=0.2-0.8×10⁻³ m (half-length of the melt pool), σAl=0.875 N/m, and σSn=0.524 N/m. As shown in FIG. 22, when Uf is on the order of 1 m/s, significant inertial forces, such as those from vaporization leading to liquid jets and mechanical waves on the surface, result in We of well above 1 for both Al and Sn. This indicates that melt pool instability, especially in shallower melt pools, is driven more by inertial forces. Conversely, for Uf on the order of 0.1 m/s, We is smaller than 1, indicating that surface tension dominates. This is observed particularly in areas farther from the keyhole and closer to the surface (upper regions) of deeper melt pools (at P=400 W and V=300 mm/s), where the surface is smoother and no significant mechanical waves are observed (FIGS. 22(a) and 21(a)-(d)). In other words, in the surface of deeper melt pools, the energy from smaller waves is effectively dampened by surface tension, resulting smoother surfaces. In the shallower melt pools, on the other hand, the more dominance of the inertial forces, not only lead to large waviness, but also result in more substantial liquid ejection out of the melt pool, thereby creating large spatters. These large spatters themselves can cause even more waviness by falling in the melt pools, thus locally changing the pattern of the flow to the direction of their impacts, as typified in FIG. 22(c). It should be noted that the Al-50Sn mixture is expected to have thermophysical properties similar to those of Al and Sn. Given that We is primarily dependent on Uf, the conclusions drawn from the We calculations for Al and Sn remain valid even if slight deviations in thermophysical properties of the Al—Sn mixture are considered.

As discussed above, methods and processes of the present disclosure establish:
1. Deeper melt pools, formed at lower scanning speeds (300 mm/s) and higher power (400 W), exhibited greater stability, with relatively smooth surfaces and consistent outward melt flow patterns. In contrast, shallower melt pools, produced at higher scanning speeds (500-700 mm/s), exhibited increased surface waviness, stronger velocity fluctuations, and formation of numerous micro-vortices.
2. The melt pool instabilities, nonuniform melt flow and re-entrance of droplets in the melt pool could lead to higher heterogeneity in Sn and Al distribution in the shallower pools.
3. Statistical analysis of keyhole instability showed that the instability occurred at the rear wall for all, while deeper keyholes with small front wall angles also displayed instability at the bottom, which is more directly exposed to the laser beam. The instability was primarily attributed to laser reflections, resulting in localized vaporization. The motion of the melt and the formation of liquid jets closely aligned with the movement of the keyhole walls and directionality of the vapor pressure (which dictate the walls' movement), indicating that the keyhole instability directly influenced the melt flow pattern.
4. Formation of rolling flows were found to be a result of the mechanical collision of the forward and backward flows moving in opposite directions, in addition to other known factors such as Marangoni forces. Additionally, slow moving flow in the vicinity of high-speed flow in the liquid jets led to the formation of inward flow circulation.
5. The velocities driven by vapor pressure and Marangoni forces were on the order of 1 m/s, several orders of magnitude larger than that caused by buoyancy forces, indicating that these forces primarily control the melt flow. However, experimental observations revealed that vapor pressure plays a more dominant role in cases where large amounts of vapor generate liquid jets and mechanical waves.
6. The significant inertial forces at high scanning speeds, compared to surface tension, were found to cause increased waviness and melt pool instability. In contrast, these forces were more balanced in melt pools formed at P=400 W and V=300 mm/s, leading to smoother surfaces and consistent outward flow.

Although aspects of the present concepts have been shown and described in detail, the examples provided are for purposes of illustration only and are not to be interpreted as a limitation on the scope of the present concepts. Numerous modifications can be made to the systems and methods of the present disclosure without departing from the scope of the present concepts. For example, the concepts of the disclosure can be applied systems other than Fe—Mg and Al—Sn, such as:
1. Au—Ag, Au—Pt, Ag—Pt and other pairs of noble metals can be synthesized in accordance with the present disclosure to have large catalytic surfaces for chemical reactions. While each of these metals are very good catalysts individually, their performance is further enhanced when they are couple together into a homogenous material system.
2. W—Cu, W—Mn, W—Cr—Combination of low activation immiscible metals such as these could potentially be used on surfaces that need to sustain continued and prolonged radiation damage. These materials also have a proclivity to form smaller grains along with an increased number of grain boundaries. These grain boundaries can act as sink for both defects during radiation damage and hydrogen trap if the material is exposed to this gaseous environment. The increased grain boundaries also strengthen the material.

What is claimed is:

1. A method of producing a biodegradable implant by additive manufacturing, comprising:
providing a substrate;
providing a feedstock comprising a first metal or metal alloy and a second metal or metal alloy having a positive enthalpy of mixing relative to the first metal or metal alloy;
providing an energy source;
positioning the feedstock between the laser and the substrate; and
activating the energy source to emit energy onto a portion of the feedstock to liquefy the portion of the feedstock and deposit the liquefied portion of the feedstock onto the substrate or onto a workpiece on the substrate.

2. The method of claim 1, wherein the first metal or metal alloy is iron or a ferrous alloy.

3. The method of claim 2 wherein the second metal or metal alloy is magnesium or a magnesium alloy.

4. The method of claim 1, wherein the first metal or metal alloy is magnesium.

5. The method of claim 1, wherein the feedstock is between about 0.05 vol % and 99.95 vol % iron or ferrous alloy and between about 0.05 vol % and 99.95 vol % magnesium or magnesium alloy.

6. The method of claim 1, wherein the or metal alloy is carbon coated iron or carbon coated ferrous alloy.

7. The method of claim 1, wherein the melting point of the first metal or metal alloy and the melting point of the second metal or metal alloy differ by at least about 50 to about 3000 °C.

8. The method of claim 1, wherein the boiling point of the second metal or metal alloy is less than the melting point of the first metal or metal alloy.

9. The method of claim 1, further including cooling the liquefied portion of the feedstock at a rate of about 10³ °K/s to about 10⁶ °K/s.

10. The method of claim 1, wherein the electrochemical potential of the second metal or metal alloy is greater than the electrochemical potential of the first metal or metal alloy.

11. The method of claim 1, wherein the feedstock includes iron, a ferrous alloy, magnesium, a magnesium alloy, manganese, copper, silver, tin, aluminum, gold, carbon, tungsten, chromium, platinum, zinc and/or calcium.

12. The method of claim 1, wherein the first metal or metal alloy is a first noble metal or metal alloy and the second metal or metal alloy is a second noble metal or metal alloy.

13. The method of claim 1, wherein the first metal or metal alloy is a powder having a particle size distribution of between about 5 μm and about 200 μm.

14. The method of claim 13, wherein the second metal or metal alloy is a powder having a particle size distribution of between about 5 μm and about 200 μm.

15. The method of claim 1, wherein the biodegradable implant comprises the second metal or metal alloy distributed in a matrix of the first metal or metal alloy.

16. The method of claim 1, further including incorporating a pharmaceutical product into the biodegradable implant.

17. The method of claim 1, wherein the energy source is a laser that has a power of between about 50 W and about 5k W.

18. The method of claim 17, wherein the laser has a spot size of about 10 microns to about 10 mm.

19. The method of claim 1, wherein the electrochemical potential of the second metal or metal alloy is greater than the electrochemical potential of the first metal or metal alloy.

20. The method of claim 1, wherein the first metal or metal alloy and the second metal or metal alloy are at least partially immiscible.

21. The method of claim 1, wherein the enthalpy of mixing between the first metal or metal alloy and the second metal or metal alloy is positive.

22. The method of claim 1, further comprising modifying the surface of the first metal or metal alloy and/or the second metal or metal alloy prior to emitting energy on a portion of the feedstock.

23. The method of claim 22, wherein the modification includes coating the surface of the first metal or metal alloy and/or the second metal or metal alloy with a material that enhances energy absorption.

24. The method of claim 22, wherein the modification includes roughening the surface of the first metal or metal alloy and/or the second metal or metal alloy.

25. The method of claim 1, further comprising modifying the surface tension of at least a portion of the liquified feedstock.

26. The method of claim 25, further comprising providing sulfur in the feed stock to modify the surface tension of at least a portion of the liquified feedstock.

27. The method of claim 1, further comprising enhancing mixing of the first metal or metal alloy and the second metal or metal alloy in the liquified portion of the feedstock by vibrating the liquified portion of the feedstock.

28. The method of claim 1, further comprising enhancing mixing of the first metal or metal alloy and the second metal or metal alloy in the liquified portion of the feedstock by applying an electric field to the liquified portion of the feedstock.

29. The method of claim 1, further comprising enhancing mixing of the first metal or metal alloy and the second metal or metal alloy in the liquified portion of the feedstock by applying a magnetic field to the liquified portion of the feedstock.

30. The method of claim 1, further comprising processing the biodegradable implant to refine phase distribution of the first metal or metal alloy and the second metal or metal alloy and/or improve bonding between the first metal or metal alloy and the second metal or metal alloy.

31. The method of claim 1, further including heat treating the biodegradable implant.

32. The method of claim 1, further including mechanically processing the biodegradable implant.

33. The method of claim 1, further including surface treating the biodegradable implant.

34. The method of claim 1, wherein the feedstock further includes a third metal or metal alloy.

35. The method of claim 34 wherein the third metal or metal alloy is at least partly immiscible with respect to the first metal or metal alloy and/or the second metal or metal alloy.

36. A method of controlling the in vivo degradation rate of a biodegradable implant, comprising:
selecting a desired range for the in vivo degradation rate of the implant;
selecting a first metal or metal alloy that has an in vivo degradation rate outside the desired range for the in vivo degradation rate of the implant;
selecting a second metal or metal alloy having an in vivo degradation rate outside the desired range for the in vivo degradation rate of the implant and which differs from the in vivo degradation rate of the first metal or metal alloy; and
producing the implant from a first amount of the first metal or metal alloy and a second amount of the second metal or metal alloy, the first and second amounts selected so that the in vivo degradation rate of the implant is within the desired range for the in vivo degradation rate of the implant.

37. The method of claim 36, wherein the biodegradable implant comprises the second metal or metal alloy distributed in a matrix of the first metal or metal alloy.

38. The method of claim 36, wherein the electrochemical potential of the second metal or metal alloy is greater than the electrochemical potential of the first metal or metal alloy.

39. The method of claim 36, wherein the implant is configured to treat a bone fracture or osteotomy and the desired range for the in vivo degradation rate of the implant is selected at least in part based on the anticipated healing time of the bone fracture.

40. The method of claim 36, wherein the first metal or metal alloy and/or the second metal or metal alloy include iron, a ferrous alloy, magnesium, a magnesium alloy, manganese, copper, silver, tin, aluminum, gold, carbon, tungsten, chromium, platinum, zinc and/or calcium.

41. The method of claim 36, wherein the first metal or metal alloy and the second metal or metal alloy are at least partially immiscible.

42. The method of claim 36, wherein the enthalpy of mixing between the first metal or metal alloy and the second metal or metal alloy is positive.

43. A method of controlling in vivo pH at the site of an implant, comprising:
selecting a desired in vivo pH range at the implant site;
selecting a first metal or metal alloy that produces a first in vivo reaction product as the first metal or metal alloy degrades, the first in vivo reaction product having a first effect on in vivo pH at the implant site;
selecting a second metal or metal alloy that produces a second in vivo reaction product as the second metal or metal alloy degrades, the second in vivo reaction product having an opposing effect on in vivo pH at the implant site as compared to the effect of the first reaction product; and
producing the implant from a first amount of the first metal or metal alloy and a second amount of the second metal or metal alloy, the first and second amounts selected so that the combined effects of the first reaction product and the second reaction product produce at pH at the implant site that is within the desired in vivo pH range at the reaction site.

44. The method of claim 43, wherein the biodegradable implant comprises the second metal or metal alloy distributed in a matrix of the first metal or metal alloy.

45. The method of claim 43, wherein the desired in vivo pH range at the implant site is between about 6.0 and about 8.0.

46. The method of claim 43, wherein the first metal or metal alloy and/or the second metal or metal alloy include iron, a ferrous alloy, magnesium, a magnesium alloy, manganese, copper, silver, tin, aluminum, gold, carbon, tungsten, chromium, platinum, zinc and/or calcium.

47. The method of claim 43, wherein the first metal or metal alloy and the second metal or metal alloy are at least partially immiscible.

48. The method of claim 43, wherein the enthalpy of mixing between the first metal or metal alloy and the second metal or metal alloy is positive.

49. A biodegradable implant made in accordance with the method of claim 43.

50. A method of producing a structure by additive manufacturing, comprising:
providing a substrate;
providing a feedstock comprising a first metal or metal alloy and a second metal or metal alloy that is immiscible with respect to the first metal or metal alloy;
providing an energy source;
positioning the feedstock between the source of energy and the substrate; and
activating the source of energy to melt a portion of the feedstock and deposit the melted portion of the feedstock onto the substrate or onto a workpiece on the substrate.

51. The method of claim 50, wherein the feedstock includes iron, a ferrous alloy, magnesium, a magnesium alloy, manganese, copper, silver, tin, aluminum, gold, carbon, tungsten, chromium, platinum, zinc and/or calcium.

52. The method of claim 50, wherein the first metal or metal alloy and the second metal or metal alloy are at least partially immiscible.

53. The method of claim 50, wherein the enthalpy of mixing between the first metal or metal alloy and the second metal or metal alloy is positive.

54. The method of claim 50, further comprising modifying the surface of the first metal or metal alloy and/or the second metal or metal alloy prior to activating the source of energy.

55. The method of claim 54, wherein the modification includes coating the surface of the first metal or metal alloy and/or the second metal or metal alloy with a material that enhances energy absorption.

56. The method of claim 54, wherein the modification includes roughening the surface of the first metal or metal alloy and/or the second metal or metal alloy.

57. The method of claim 50, further comprising modifying the surface tension of at least a portion of the melted feedstock.

58. The method of claim 57, further comprising providing sulfur in the feed stock to modify the surface tension of at least a portion of the melted feedstock.

59. The method of claim 50, further comprising enhancing mixing of the first metal or metal alloy and the second metal or metal alloy in the melted portion of the feedstock by vibrating the melted portion of the feedstock.

60. The method of claim 50, further comprising enhancing mixing of the first metal or metal alloy and the second metal or metal alloy in the melted portion of the feedstock by applying an electric field to the melted portion of the feedstock.

61. The method of claim 50, further comprising enhancing mixing of the first metal or metal alloy and the second metal or metal alloy in the melted portion of the feedstock by applying a magnetic field to the melted portion of the feedstock.

62. The method of claim 50, further comprising processing the structure to refine phase distribution of the first metal or metal alloy and the second metal or metal alloy and/or improve bonding between the first metal or metal alloy and the second metal or metal alloy.

63. The method of claim 50, further including heat treating the structure.

64. The method of claim 50, further including mechanically processing the structure.

65. The method of claim 50, further including surface treating the structure.

66. The method of claim 50, wherein the structure is a biodegradable implant.

67. The method of claim 50, wherein the additive manufacturing process is laser beam powder bed fusion.

68. The method of claim 50, wherein the additive manufacturing process is electron beam powder bed fusion.

69. The method of claim 50, wherein the additive manufacturing process is direct energy deposition.

70. The method of claim 50, wherein the feedstock further includes a third metal or metal alloy.

71. The method of claim 70, wherein the third metal or metal alloy is at least partly immiscible with respect to the first metal or metal alloy and/or the second metal or metal alloy.

72. The method of claim 50, wherein at least one of the first metal or metal alloy or the second metal or metal alloy is carbon coated.

73. The method of claim 50, wherein the feedstock includes more than two metal or metal alloys and at least two of the feedstock metals or metal alloys have a positive enthalpy of mixing relative to one another.

74. The method according to claim 50, further including providing an excess amount of at least one of the first metal or metal alloy or the second metal or metal alloy to account for material loss occurring when the method is performed.

75. The method of claim 50, wherein the application of energy to the feedstock results at least in part in a solid state bond between the first metal or metal alloy and the second metal or metal alloy.
